(19) United States
(12) Patent Application Publication
(10) Pub. No.: US 2019/0327757 A1
(43) Pub. Date: Oct. 24, 2019

(54) URLLC AND eMBB DATA MULTIPLEXING COMMUNICATIONS

(71) Applicant: IDAC HOLDINGS, INC., Wilmington, DE (US)

(72) Inventors: Oghenekome Oteri, San Diego, CA (US); Liangping Ma, San Diego, CA (US); Seyed Mohsen Hosseinian, San Diego, CA (US); Shahrokh Nayeb Nazar, San Diego, CA (US); Frank La Sita, Setauket, NY (US)

(73) Assignee: IDAC HOLDINGS, INC., Wilmington, DE (US)

(21) Appl. No.: 16/475,620

(22) PCT Filed: Jan. 5, 2018
(86) PCT No.: PCT/US2018/012592

§ 371 Date: Jul. 2, 2019

Related U.S. Application Data
(60) Provisional application No. 62/443,532, filed on Jan. 6, 2017.
(60) Provisional application No. 62/454,377, filed on Feb. 3, 2017.
(60) Provisional application No. 62/500,950, filed on May 3, 2017.
(60) Provisional application No. 62/569,297, filed on Oct. 6, 2017.

(51) Int. Cl. H04W 72/12; H04W 72/14; H04W 72/04; H04L 5/00; H04L 1/00

(52) U.S. Cl. CPC H04W 72/1284; H04W 72/14; H04L 1/0013; H04W 72/0406; H04L 5/0053; H04W 72/0446

(57) ABSTRACT

A wireless transmit/receive unit (WTRU) may receive a configuration message that includes scheduled resources to communicate a scheduling request (SR) for uplink (UL) transmission during a configured downlink (DL) slot for enhanced mobile broadband (eMBB) communication. The configured downlink slot may have mini-slots to switch communications for UL or DL ultra-reliable low latency communication (URLLC) information. The WTRU may monitor a physical downlink control channel (PDCCH) for an UL grant, in response to a transmitted SR, in DL mini-slots following the transmitted SR.

### CROSS REFERENCE TO RELATED APPLICATIONS

This application claims the benefit of U.S. Provisional Application Ser. No. 62/443,532 filed Jan. 6, 2017, U.S. Provisional Application Ser. No. 62/454,377 filed Feb. 3, 2017, U.S. Provisional Application Ser. No. 62/500,950 filed May 3, 2017, and U.S. Provisional Application Ser. No. 62/569,297 filed Oct. 6, 2017, the contents of which are hereby incorporated by reference herein.

### BACKGROUND

Fifth generation (5G) wireless systems and networks may utilize new frames, multiplexing, and waveforms for downlink communications, uplink communications, and advanced beam management. These new waveforms and frames may be utilized to provide enhanced mobile broadband (eMBB), ultra-reliable low latency communication (URLLC), massive Machine Type Communication (mMTC), etc. for a new radio (NR) access technology.

Communications in 5G wireless systems may be sporadic, infrequent, bursty, use small payloads, unscheduled, or unpredictable for downlink and uplink communications. For instance, MTC communications, especially in the uplink, may be desired by devices when a measurement is made, an event occurs, or an environmental condition is met. For these types and other 5G communications, low latency is desirable for URLLC, eMBB, mMTC, or the like.

### SUMMARY

Data communications in 5G and a new radio (NR) NodeB or next generation node-B (gNB) is provided. Enhanced mobile broadband (eMBB) traffic may be communicated in a time slot. Ultra-reliable low latency communication (URLLC) traffic may be received during the time slot on the downlink (DL). In a subsequent time slot for uplink (UL) communications, the time slot may be switched to DL and the URLLC traffic transmitted or communicated during the subsequent time slot.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example of a wireless transmit/receive unit (WTRU);

FIG. 1C is a system diagram illustrating an example of a radio access network (RAN) and an example of a core network (CN) that may be used within the communications system illustrated in FIG. 1A;

FIG. 1D is a system diagram illustrating a further example of a RAN and a further example of a CN that may be used within the communications system illustrated in FIG. 1A;

FIG. 2 is a signal diagram illustrating an example of multiplexing of ultra-reliable low latency communications (URLLC) and enhanced mobile broadband (eMBB) communications;

FIG. 3 is a signal diagram illustrating an example of multiplexing of URLLC and eMBB communications with radio resource allocation regions (RRARs);

FIG. 4 is an exemplary process to indicate the presence of a pending uplink (UL) URLLC communication;

FIG. 5 is an exemplary process for pre-emptive downlink (DL) URLLC communications in time division duplexing (TDD) mode;

FIG. 6 is a signal diagram illustrating an example of multiplexing of URLLC and eMBB communications;

FIG. 7 is a signal diagram illustrating an example of UL and DL eMBB slots and virtual UL and DL URLLC mini-slots;

FIG. 8 is a signal diagram illustrating an example of a TDD mini-slot and an example of a frequency division duplex (FDD) mini-slot;

FIG. 9 is a signal diagram illustrating an example of monitoring intervals for URLLC and eMBB multiplexing in a FDD communication mode;

FIG. 10 is a process illustrating an example of pre-emptive link switching for URLLC UL communications in TDD;

FIG. 11 is a signal diagram illustrating an example of UL eMBB communication pre-empted by an UL URLLC grant free communication;

FIG. 12 is a signal diagram illustrating an example of UL eMBB communication pre-empted with an UL URLLC scheduled communication;

FIG. 13 is a signal diagram illustrating an example of a DL eMBB communication pre-empted by an UL URLLC grant free communication;

FIG. 14 is a signal diagram illustrating an example of a DL eMBB communication pre-empted by an UL URLLC scheduled communication;

FIG. 15 is a signal diagram illustrating an example of a DL eMBB communication pre-empted with an uplink URLLC scheduled/grant based communication;

FIG. 16 is a process which illustrates an exemplary procedure by an eMBB device;

FIG. 17 is a process which illustrates an exemplary procedure by an URLLC device;

FIG. 18 is a signal diagram illustrating an example of an UL eMBB communication with UL URLLC pre-emption and reserved URLLC pre-emption mini-slots;

FIG. 19 is an exemplary process performed by an eMBB device;

FIG. 20 is an exemplary process performed by an URLLC device;

FIG. 21 is a signal diagram illustrating an example of configuring dynamic UL pre-emptive indications;

FIG. 22 is an exemplary process performed by an eMBB device;

FIG. 23 is an exemplary process performed by an URLLC device;

FIG. 24 is a signal diagram illustrating an example of a URLLC WTRU that is requested by next generation node-B (gNB) to wait for a grant;

FIG. 25 is a signal diagram illustrating an example of resource allocation by a FDD gNB for pre-empting URLLC communication;

FIG. 26 is a signal diagram illustrating an example of full-duplex gNB resource allocation in an UL time slot for DL URLLC communications;

FIG. 27 is a signal diagram illustrating an example of URLLC traffic insertion across less resource blocks than eMBB communications;

FIG. 28 is a signal diagram illustrating an example of URLLC traffic insertion across multiple eMBB devices;

FIG. 29 is a process illustrating an example of eMBB and URLLC multiplexing with dynamic eMBB numerology;

FIG. 30 is a process of an example where numerology of the eMBB data is not changed;

FIG. 31 is a signal diagram showing an example of baseline URLLC traffic insertion; and

FIG. 32 is a signal diagram showing an example of URLLC traffic Insertion with dynamic eMBB numerology.

### DETAILED DESCRIPTION

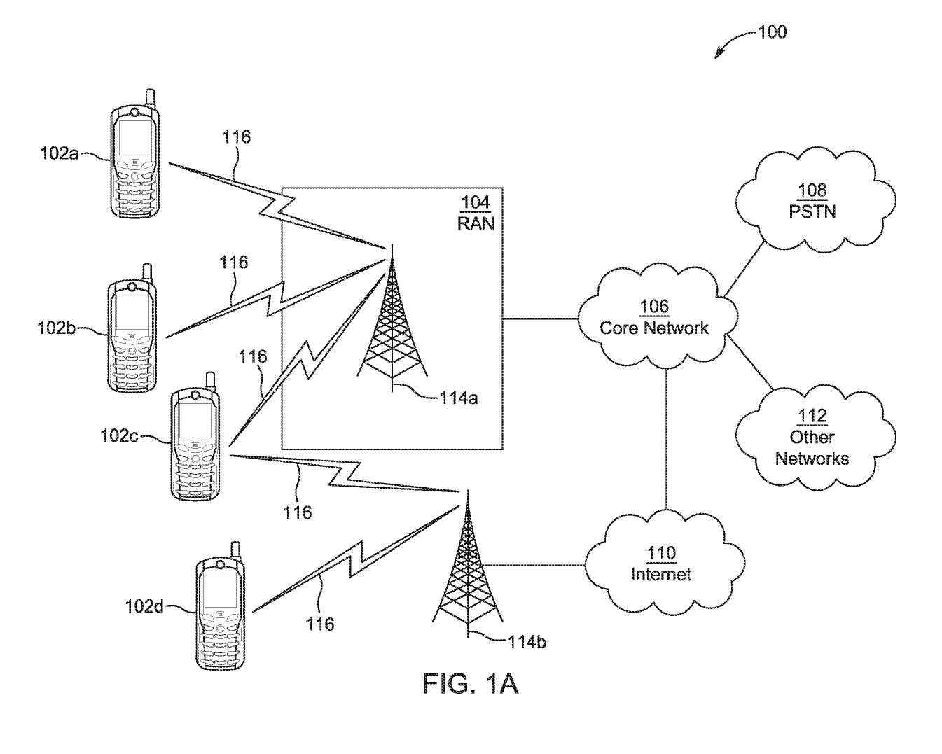

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform spread orthogonal frequency division multiplexing (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications system 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a next generation node-b (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or communications sent to/from multiple types of base stations (e.g., an eNB and a gNB).

In other embodiments, the base station 114a and the WTRUs 102a, 102b, 102c may implement radio technologies such as Institute of Electrical and Electronics Engineers (IEEE) 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the communication control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGA) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, a humidity sensor, or the like.

The WTRU 102 may include a full duplex radio for which communication and reception of some or all of the signals (e.g., associated with particular subframes for both the UL (e.g., for communication) and DL (e.g., for reception) may be substantially concurrent, synchronized, simultaneous, or the like. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which communication and reception of some or all of the signals (e.g., associated with particular subframes for either the UL (e.g., for communication) or the downlink (e.g., for reception)).

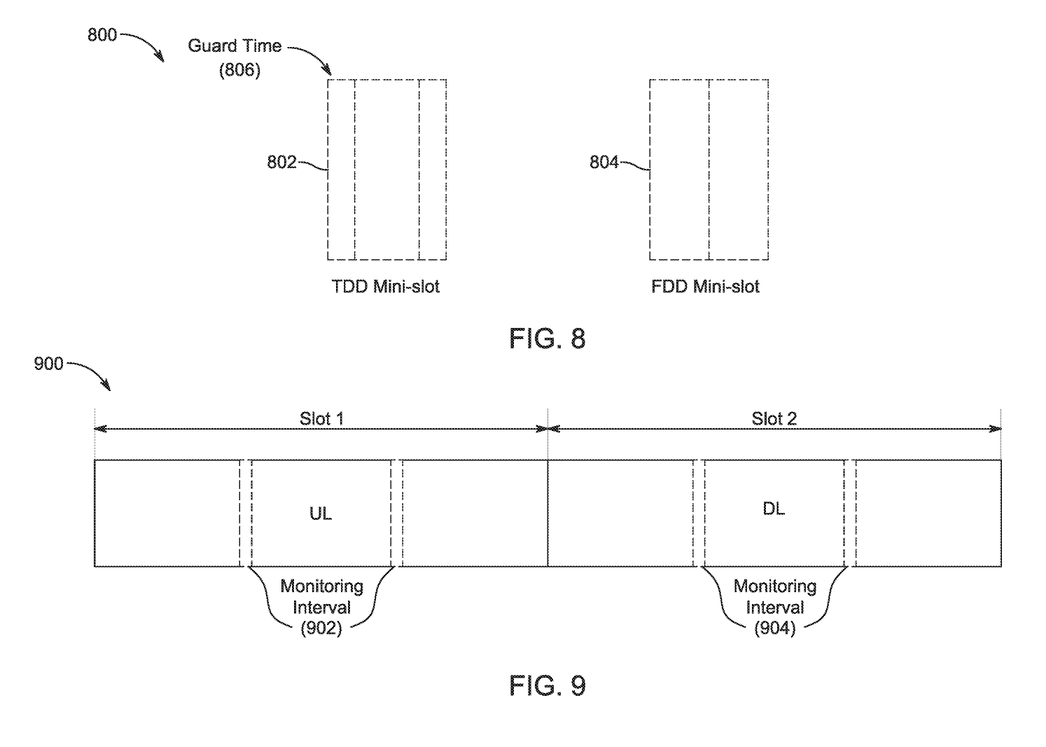

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more STAs associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width, set via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 gigahertz (GHz) modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11a, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Also, in an example, gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers (not shown) to the WTRU 102a. A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated communications from gNB 180a and gNB 180b (and/or gNB 180c).

The WTRUs 102a, 102b, 102c may communicate with gNBs 180a, 180b, 180c using communications associated with a scalable numerology. For example, the OFDM symbol spacing and/or OFDM subcarrier spacing (SCS) may vary for different communications, different cells, and/or different portions of the wireless communication spectrum. The WTRUs 102a, 102b, 102c may communicate with gNBs 180a, 180b, 180c using subframe or communication time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communication (URLLC) access, services relying on enhanced massive mobile broadband (eMBB) access, services for MTC access, and/or the like. The AMF 182a, 182b may provide a control plane function for switching between the RAN 104 and other RANs (not shown) that employ other radio technologies, such as LTE, LTE-A, LTE-A Pro, and/or non-Third Generation Partnership Project (3GPP) access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

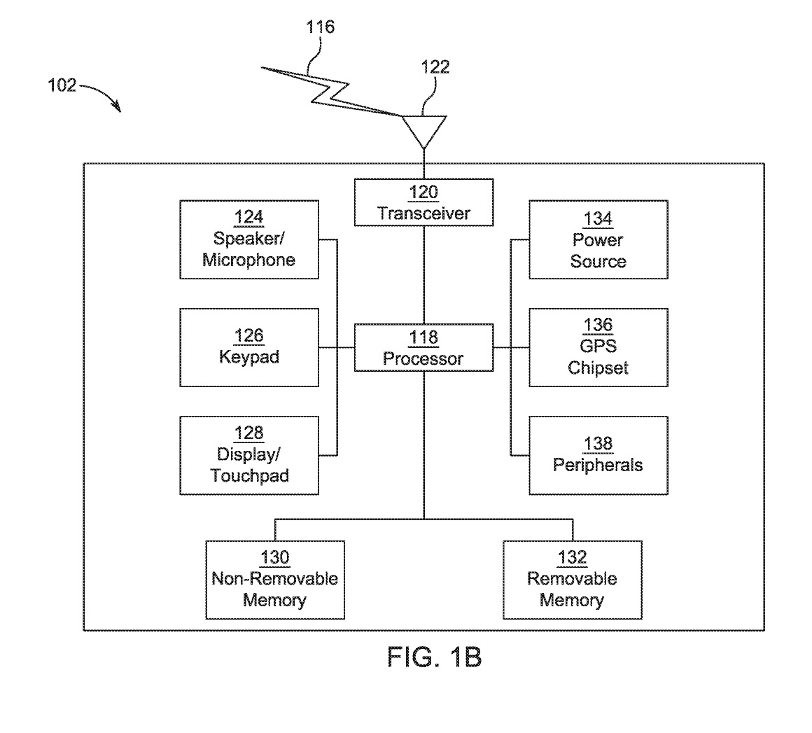

FIG. 2 is a signal diagram 200 illustrating an example of multiplexing of URLLC and eMBB communications. In signal diagram 200, a time division duplex (TDD) communication mode may be configured or utilized. However, in forthcoming examples, frequency divisional duplex (FDD) may also be configured or utilized for multiplexing or pre-empting eMBB and URLLC communications. When URLLC traffic is sporadic, higher spectral efficiency and minimum or reduced latency or delays may be achieved by pre-emptive communication of URLLC traffic over substantially co-existing, concurrent, synchronized, simultaneous, overlapping, or the like eMBB communication. However, for the TDD case, use of slots or time slots 1-4 may be constrained due to duplexing. During the communication of eMBB traffic 202, URLLC traffic may arrive.

In signal diagram 200, URLLC traffic 204 may arrive for service at the gNB, such as any one of gNBs 180a, 180b, 180c. A NR NodeB may also be substituted for a gNB. In this example, slot 2, the current time slot, may be configured or designated as UL. The next DL time slot may be configured or designated as slot 4 to communicate DL information 206. If the gNB starts the communication of the URLLC traffic in Slot 4, delay T1 may be more than 1 time slot duration, resulting in latency that is unacceptable for certain types of URLLC traffic. In some case, latency may be as large as the duplex switching time interval.

For signal diagram 200, a gNB may pre-emptively switch duplexing direction to accommodate traffic 208 when downlink URLLC traffic 210 arrives to improve efficiency, reduce interference, and reduce latency for URLLC communications. Pre-emption may be explicitly or implicitly determined by an eMBB device or URLLC device. For example, the gNB may change the duplexing direction of slot 2 from UL to DL, transmit URLLC traffic 212 and change back to UL in slot 2 as soon as the downlink URLLC traffic is transmitted or communicated. This may result in the latency for the URLLC traffic T₂ to be significantly lower than T₁.

A target user plane latency for URLLC communications may be 0.5 milliseconds (ms) or less for both UL and DL. Various performance indicators, such as key performance indicators (KPIs), for URLLC may cover reliability requirements, spectrum efficiency, user experience data, 5th percentile user spectrum efficiency, connection density, or the like. Performance may depend on deployment and operation configurations. For example, reliability may be evaluated based on the probability of successfully transmitting X bytes within a certain delay. The delay may be the time it takes to deliver a small data packet from the radio protocol layer 2/3 service data unit (SDU) ingress point to the radio protocol layer 2/3 SDU egress point of the radio interface at a certain channel quality, such as coverage-edge.

For data channel communications, as shown in signal diagram 200, URLLC data may arrive after resources are allocated for eMBB data. In certain configurations, the URLLC data may be multiplexed with existing eMBB data in a manner that takes into consideration the latency requirements for the URLLC data. eMBB communications may be more delay or latency tolerant than URLLC data. The eMBB data being decoded effectively by the URLLC WTRU or any device may also be a consideration.

When a gNB operates in a half-duplex mode, pre-emptive switching, as shown in traffic 208, may cause UL or DL communications to fail. Failed or disrupted eMBB communication may be recovered via retransmission. Specifically, a gNB may identify failed UL communications by referring to an UL schedule generated and sent by a gNB for the affected slot or time slot, and may send NACKs for a failed UL communication. If the UL communication is URLLC traffic, a gNB may evaluate the possible costs of applying the pre-emptive duplex direction switching.

In order to control possible or potential disruptions, a gNB may evaluate the probability that there is one or more UL URLLC communications in a time slot in which the URLLC traffic arrives at the gNB for downlink communication. The probability may be determined by obtaining historical statistics, artificial intelligences models, big data, etc. on URLLC communication, and higher layer information about the existence of ongoing URLLC sessions. If the probability is determined to be low, a gNB can proceed to perform pre-emptive duplex direction switching from UL to DL or from DL to UL.

A gNB may also compare QoS classes of DL URLLC communications with those of UL URLLC communications, and may perform pre-emptive duplex direction switching if the former has higher priority than the latter. Within the URLLC traffic, traffic may be further differentiated by certain QoS requirements. For example, gaming traffic may not be as critical as remote surgery traffic and may be designated as a lower priority.

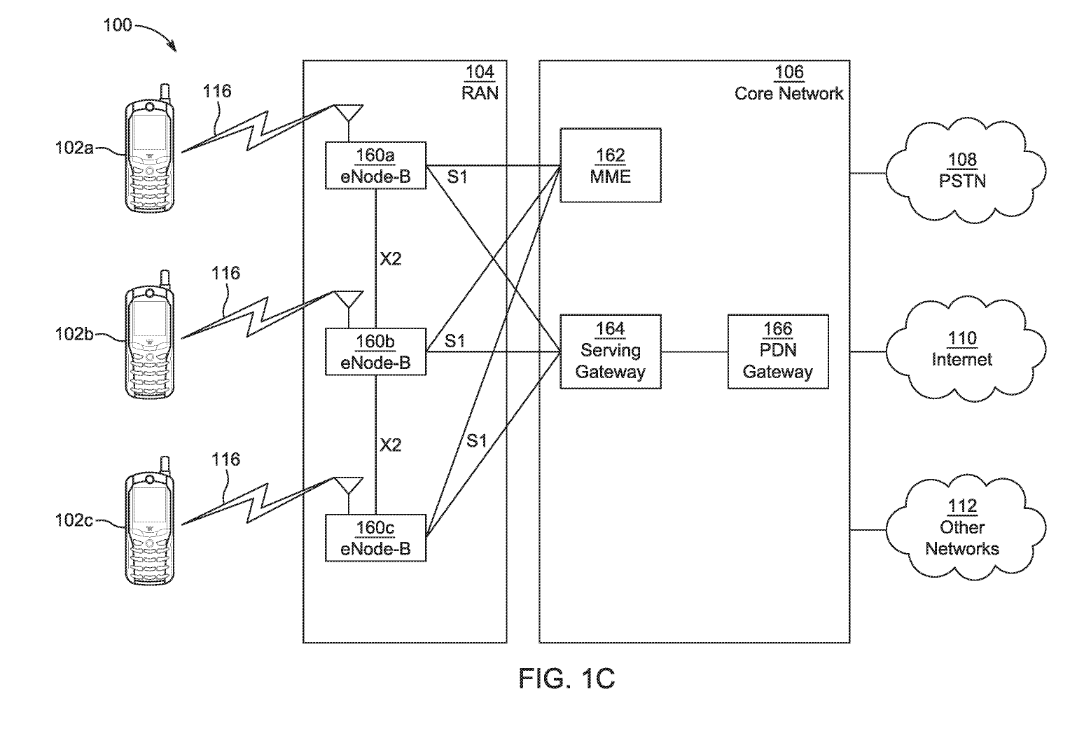

FIG. 3 is a signal diagram 300 illustrating an example of multiplexing of URLLC and eMBB communications with radio resource allocation regions (RRARs). An RRAR may be a designated or special reserved region or resources of UL time slot 2 for UL communications configured by the network. Switching to DL communications may be avoided or disallowed during a RRAR. DL URLLC data may arrive at 302. A gNB, such as any one of gNBs 180a, 180b, 180c, may reserve one or more RRARs 304 or 308 in an UL time slot 2 to be used by URLLC WTRUs or URLLC devices. A NR NodeB may also be substituted for a gNB. When a gNB pre-emptively switches from UL to DL at 306, RRARs 304 and 308 may be avoided. In signal diagram 300, Delay T₂′ may be larger than T₂ in signal diagram 200 where RRARs are not reserved.

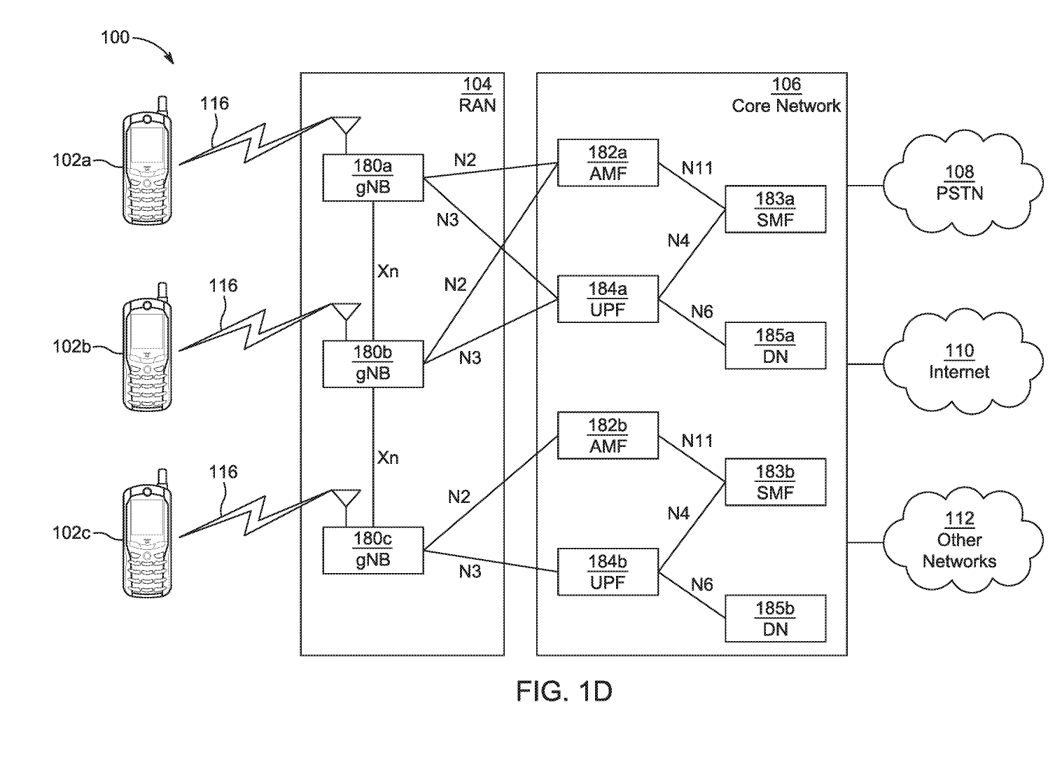

FIG. 4 is an exemplary process 400 to indicate the presence of a pending UL URLLC communication. When the same WTRU, such as WTRU 102, or any device may originate both URLLC traffic and eMBB traffic (402), the WTRU may indicate in UL communication (404) if an UL URLLC communication, or NACK-less retransmission, is pending or has information to send. A predetermined set of time-frequency resources may be allocated for the URLLC presence indicator. As an example, the predetermined set of resources can be the first n resource elements in the resource elements allocated to that WTRU to allow the gNB to pre-emptively switch the duplex direction in a timely manner if desired, where n is configurable in a system information bit (SIB), RRC signaling, or the like. After the indication, the WTRU may add URLLC traffic to the current transmission (406).

Where there is no pending URLLC communication (408), the WTRU may not add the indicator. This can have the advantage of minimizing or saving the use of resources. To distinguish the presence indicator from the rest of the data or control information from a particular WTRU, the indicator may be a sequence of known bits with cyclic redundancy check (CRC) bits, or a channel coded version of such a sequence of known bits with CRC bits. Where a gNB has a need to pre-emptively switch the duplex direction, it may attempt to decode the indicator carried on the predetermined resources. If the gNB finds an indicator from any of the WTRUs that it is associated, the gNB may refrain from performing the pre-emptive duplex direction switching.

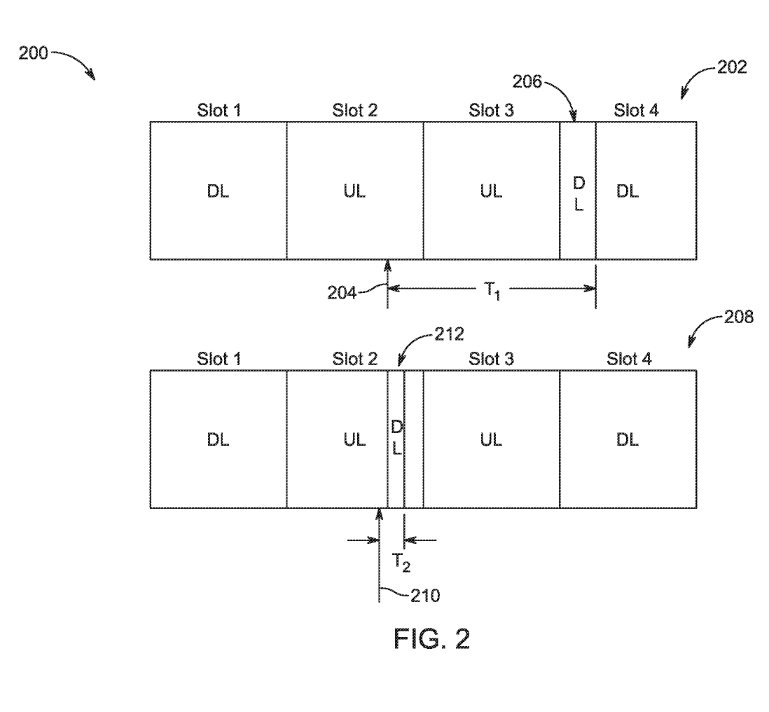

FIG. 5 is an exemplary process 500 for pre-emptive DL URLLC communications in TDD mode. A WTRU, such as WTRU 102, or any device may be pre-configured or prepared for URLLC communication from or by a gNB, such as any one of gNBs 180a, 180b, 180c. When a WTRU or any device is scheduled to transmit (502), the WTRU may stay in transmit mode (504). When a scheduled transmission is complete (506), it may be determine whether the WTRU is in a URLLC session (508). When a scheduled transmission is still on-going or not complete, there may be a wait for a predetermined time period (512) and a stay in TX mode. When in a URLLC session, a switch to receive (RX) mode may be made and a wait for potential DL URLLC transmission initiated (510). Otherwise, there is a stay in TX mode (514).

In process 500, a gNB may perform pre-emptive duplex mode switching without receiving control signaling that indicates an upcoming URLLC communication. In certain TDD mode operations, a WTRU may not listen or monitor a channel during an UL time slot. In a pre-emptive TDD switching mode, a WTRU that is not transmitting may operate a radio in a listening or monitoring mode. When a WTRU indicates in UL communication that an UL URLLC communication is pending, each WTRU may indicate the presence or absence of an imminent UL URLLC communication. This operation may be performed regardless of the presence or absence of an imminent UL URLLC communication. The indicator may use a known channel coding scheme, repetition coding, or the like. A WTRU can add an indicator, and the gNB may search for or decode the indicator in the communication from each WTRU. If there is an indicator that indicates an imminent UL URLLC communication, the gNB may refrain from pre-emptively switching the duplexing direction. Otherwise, the gNB can pre-emptively switch the duplexing direction.

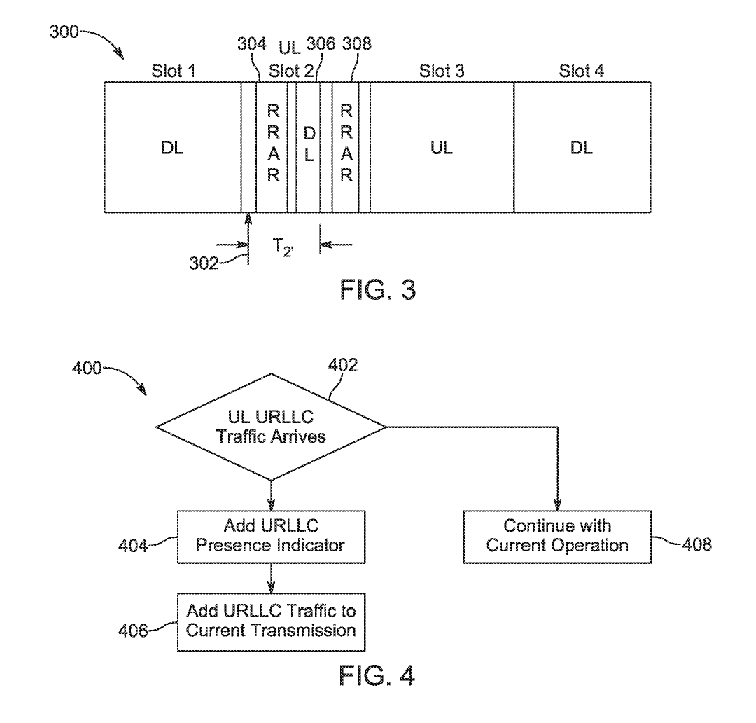

FIG. 6 is a signal diagram 600 illustrating an example of multiplexing of URLLC and eMBB communications. Traffic 602, 608, and 618 illustrates different communication outcomes or scenarios. With slots 1-4, T1 may be the latency experienced when using TDD without pre-emption when URLLC information arrives 606 but an UL communication is next available at 604. With pre-emptive uplink switching for a URLLC UL communication for traffic 608 or 618, when DL URLLC arrives at 610 or 620, latency may be reduced to T₂.

URLLC traffic may arrive at a WTRU, such as WTRU 102, for service. However, the current time slot or slot 2 may be configured or designated as DL with the next UL time slot available at or set as slot 4. If the WTRU or any device begins the communication of URLLC traffic in slot 4, delay T1 may be more than 1 time slot duration. This delay may not satisfy certain latency requirements for URLLC traffic. For URLLC UL communication, the gNB may change the duplexing direction of slot 2 from DL to UL at 616 or 628, allow communication of the URLLC traffic, and change back to DL (e.g., to allow the continued communication of eMBB traffic) in slot 3 as soon as the UL URLLC traffic is transmitted or communicated. Granularity of the change within a communication interval may be a mini-slot, small slot, short slot, or the like which may be consecutive or patterned symbols. The size of the mini-slot may range from 1 symbol to the total_number_of_symbols_in_a_slot-1 symbol.

A gNB may configure or utilize a short PUCCH 614 or 624 in every slot to allow URLLC WTRUs to send a scheduling request (SR) at 612 or 622 on each slot and based on the information sent, to allow the gNB to pre-emptively schedule UL resources for UL URLLC communication in scheduled URLLC communications. Short PUCCH 624 may be frequency constrained to allow the simultaneous communication of UL data 626 on the symbol transmitted.

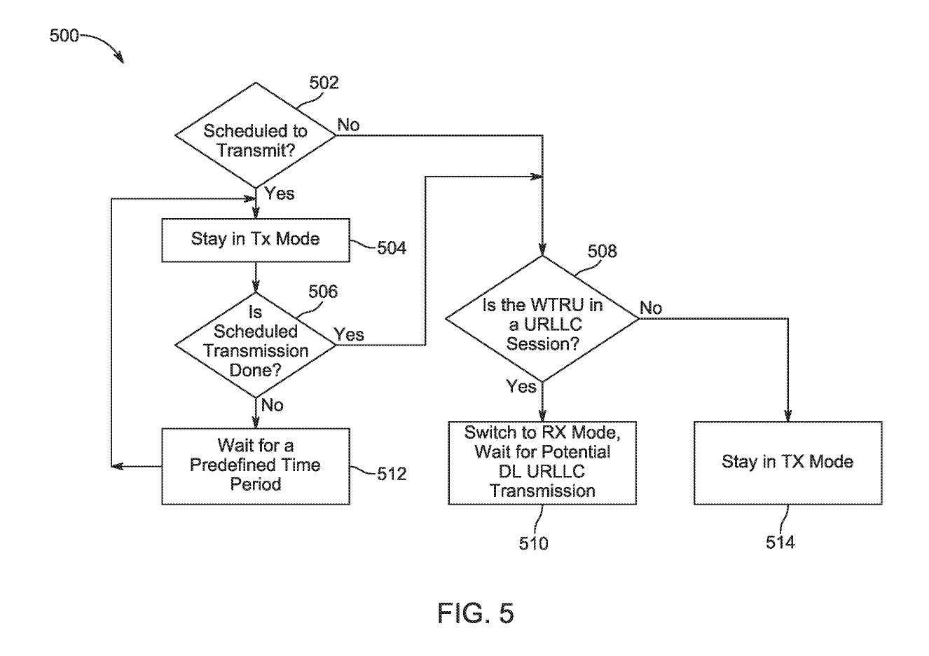

FIG. 7 is a signal diagram 700 illustrating an example of UL and DL eMBB slots, and virtual UL and DL URLLC mini-slots. A regular, full-sized, common, or typical slot may be divided into multiple virtual mini-slots which may or may not be used for communication in any given regular or full-sized slot. Virtual mini-slots may be dynamically configured by scheduler to be utilized for UL or DL or combined UL/DL communications, as desired. For eMBB traffic 702, slot 1 and slot 2 may be regular timeslots of duration 704 and 708, respectively. Pre-emptive scheduling request (PSR) 706 and 710 may be configured in traffic 702.

For URLLC traffic 712, a virtual mini-slot may be configured for switched DL slot 714, switched UL slot 716, and switched UL slot 718. A virtual mini-slot may be defined for substantially an entire slot. For URLLC, a virtual mini-slot may also be configured in the same direction as the eMMB slot or counter the direction of the eMMB slot. Parts of traffic 702 and 712 may be substantially co-existing, concurrent, synchronized, simultaneous, or the like. Any one of these slots may also be configured as a combined UL/DL mini-slot. A combined UL/DL mini-slot may include a single symbol, such as an OFDM symbol, for DL and the rest of the mini-slot utilized or transmitted as UL. In this configuration, a single OFDM symbol may be a URLLC control region to signal or carry uplink scheduling information. After the control region, traffic may be switched to TDD uplink to transmit or communicate scheduled data using one or more symbols.

In TDD scenarios where a regular or full-sized slot is configured as UL, upon arrival of an URLLC packet for DL communication, a gNB, such as any one of gNBs 180a, 180b, 180c, may schedule a virtual mini-slot as a DL mini-slot and may switch communication from UL to DL for duration of that mini-slot, such as in slot 1 in traffic 712. A NR NodeB may also be substituted for a gNB. A gNB may also schedule a virtual mini-slot as UL/DL mini-slot and switch communication between DL and UL communication during the mini-slot, such as in slot 2 of FIG. 7.

Virtual mini-slots may be configured for data communication, control communication, or data and control communications. If a mini-slot is configured for data communication, control signaling may be performed through cross mini-slot scheduling where a control channel transmitted outside of the mini-slot may carry scheduling information for the data to be transmitted within the data mini-slot. Control signaling may be at the beginning of the slot or may be carried by control signaling transmitted in a control mini-slot. In cases where a mini-slot is configured to carry control information, the mini-slot may carry the control signaling for multiple WTRUs to be scheduled in subsequent data mini-slots. For example, in cases where multiple mini-slots are aggregated within a 1 ms subframe, the first mini-slot may be control, carrying control information such as downlink control information (DCI), and the subsequent mini-slots may be data, carrying one or more downlink channels such as physical downlink shared channels (PDSCHs).

If a single or same mini-slot is configured for both data and control information communication, a WTRU or any device may monitor DCI within that mini-slot to determine scheduling information for WTRU data within that mini-slot. In cases where a mini-slot is comprised of multiple OFDM symbols, control channels, such as physical downlink control channels (PDCCHs), may be mapped to the first OFDM symbol. When a mini-slot is comprised of one OFDM symbol, data and control channels may be jointly encoded and transmitted on the single OFDM symbol.

Jointly encoding data and control channels on a single OFDM symbol may be a configuration desirable for millimeter-wave (mmWave) applications where the bandwidth allocated over a short time duration may be large. In this configuration, a WTRU may first detect and decode the jointly encoded data and control information, then determine whether the data packet is intended for the WTRU by processing the CRC. A WTRU may also perform blind decoding over a set of jointly encoded data and control candidates to determine whether there is allocation for the WTRU within a given mini-slot. Joint encoding of data and control information may be performed using the same forward error correction (FEC) scheme, such as polar codes, for transmission on a single physical channel. A physical channel carrying jointly encoded data and control may be different from a physical data channel, such as PDSCH, and physical control channel, such as PDCCH.

A URLLC WTRU, such as WTRU 102, or URLLC device may adjust a receiver to monitor a control region for a virtual mini-slot for possible assignments regardless of whether the regular or full-sized slot is configured as DL or UL. An eMBB WTRU or eMBB device may monitor the control region of a regular or full-sized DL slots. A subset of pre-configured virtual mini-slots may also be monitored to reduce computational complexity associated with monitoring the DL at a single virtual mini-slot. Monitoring a subset of pre-configured virtual mini-slots may be desirable for mmWave applications where virtual mini-slot durations are short, and the latency requirement can be met even if the DL communication is not scheduled for the URLLC WTRU upon arrival of a URLLC data packet.

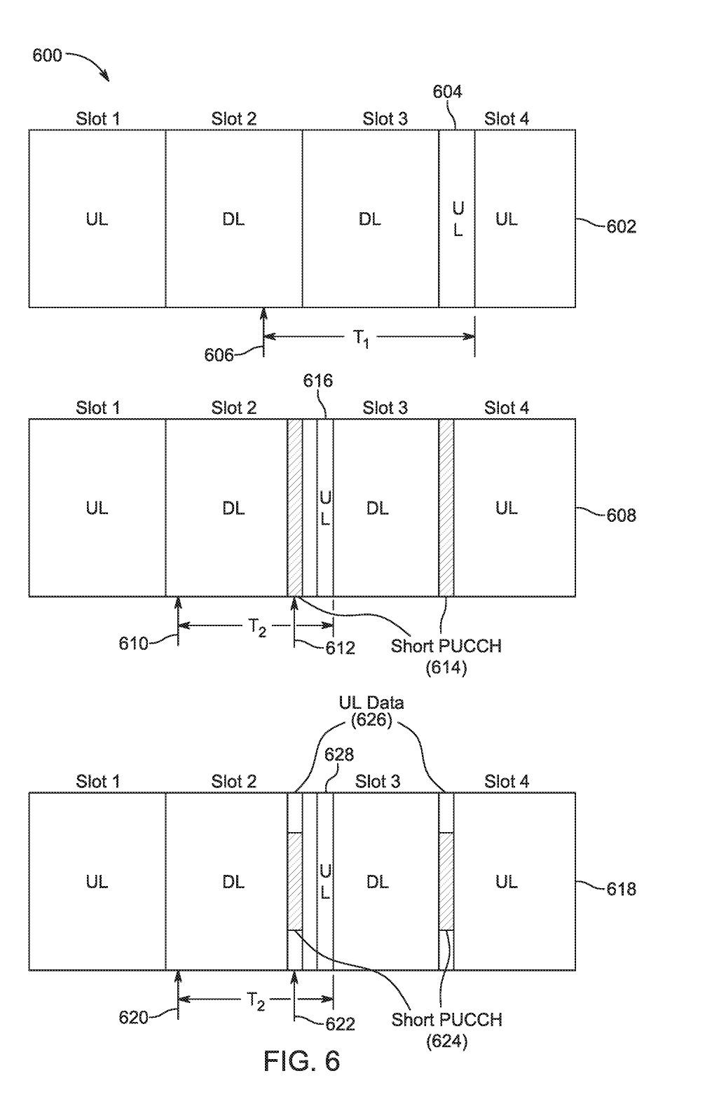

FIG. 8 is a signal diagram 800 illustrating an example of a TDD mini-slot 802 and an example of a FDD mini-slot 804. Guard time, interval, or band 806 may be utilized at the start and at the end of each mini-slot to have time to switch between the UL and DL. Such time may be desirable for radio frequency (RF) adjustments, switching, or the like. A guard time, interval, or band may be half of or a whole symbol, such as an OFDM symbol. Due to a guard time, a TDD mini-slot may be different from FDD. For example, TDD mini-slot 802 that is configured with half an OFDM symbol guard band may carry one OFDM symbol for data communication while FDD mini-slot 804 may be configured for two OFDM symbols for data communication.

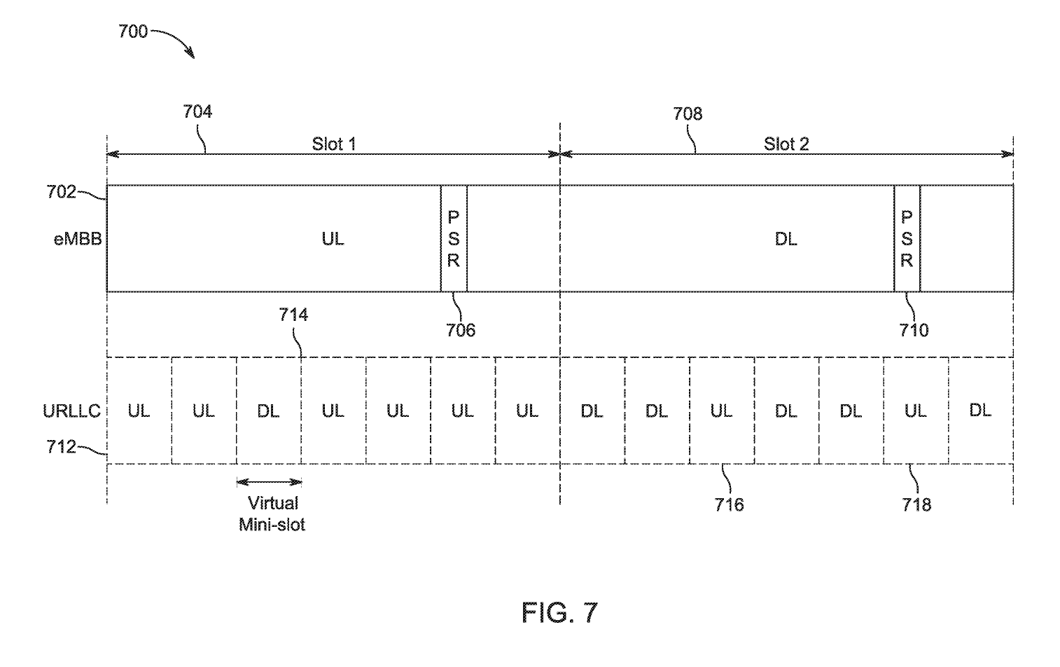

FIG. 9 is a signal diagram 900 illustrating an example of monitoring intervals for URLLC and eMBB multiplexing in a FDD communication mode. In FIG. 9, short discontinuous transmission (DTX) or monitoring intervals 902 may be scheduled in any configured UL slot 1 for URLLC WTRUs or URLLC devices to listen for DL communications. Short DTX or monitoring intervals 904 may also be scheduled within each DL regular or full-sized slot 2 for a gNB to listen for possible UL communications by URLLC WTRUs or URLLC devices. The periodicity of short DTX or monitoring intervals 902 may be configurable and may depend on the frequency band. In higher bands such as mmWave, the periodicity may be longer given short symbol durations.

For UL communication in TDD, when a regular, full-sized, or common slot may be configured or arranged as DL, a URLLC WTRU or URLLC device may autonomously transmit an uplink data packet within a virtual UL mini-slot. A gNB, such as any one of gNBs 180a, 180b, 180c, may configure a set of UL virtual mini-slots within a regular or full-sized DL slot for possible communications by URLLC WTRUs. A NR NodeB may also be substituted for a gNB. During these UL virtual mini-slots, the gNB may lower DL communication power or energy requirements for certain resource elements within a region where a virtual UL mini-slot overlaps with the regular or full-sized DL slot. This may lower noise or interference caused by DL communications on the UL communications by URLLC WTRUs or URLLC devices.

In addition, a URLLC WTRU, such as WTRU 102, may send a scheduling request before initiating UL communications within a regular or full-sized slot configured for DL communication. The scheduling request may be transmitted on certain or pre-configured resource elements (REs) of a DL slot. A gNB may puncture those resource elements within each regular or full-sized DL slot such that no interference or less interference is caused by DL communications on the UL scheduling request communications.

Pre-emptive link switching for URLLC UL communication in TDD virtual mini-slots may also be utilized for eMBB and URLLC multiplexing. Virtual mini-slots may be used for both grant free and scheduled URLLC UL communications. For a grant-free communication, a URLLC WTRU, such as WTRU 102, or URLLC device may transmit pre-emptive UL data in the next or subsequent configured UL virtual mini-slot in a given UL/DL normal slot. If multiple URLLC WTRUs have traffic to send in the UL and choose the same UL virtual mini-slot, collisions may occur. To reduce collisions, a URLLC WTRU may randomly choose one of the UL virtual mini-slots in a certain time period, for example, the next half of a normal slot. A hash function that takes the WTRU ID as the key and returns a value may also be utilized to determine a virtual mini-slot in a future time period for the UL communication. For instance, a hash function f(WTRU ID)=x may be utilized where the WTRU may access a channel x virtual mini-slots from the current time or x UL virtual mini-slots from the current time.

A URLLC WTRU or URLLC device may also repeat communications a desired number, such as X or K, times to increase the probability of reception. For instance, a URLLC WTRU or URLLC device may repeat communication within the same slot. The communications may be over multiple UL virtual mini-slots within the slot. A URLLC WTRU may also repeat communication over different slots to decrease the probability that it is interfered with by different WTRUs (e.g., instead of colliding with one same WTRU by randomizing the interference pattern). In addition, a URLLC WTRU may repeat communication in a slot where a gNB modified eMBB communication to blank the communication during the first UL mini-slot resource. This may be performed where a gNB detected an increase in received energy but was unable to decode the information, such as due to errors.

Referring again to FIG. 7, for a schedule-based communication, a URLLC WTRU or URLLC device may transmit a request for pre-emptive UL scheduling in a given UL/DL normal slot using a PSR 706 or 710. The resources allocated to the PSR may be configurable, aperiodic, periodic, or the like. The configurable periodicities may be set by utilization of monitoring intervals 902 or 904. In addition, location of the PSR and the switched slots may be configured by a DCI or semi-persistent scheduling (SPS) configuration and may be known to both eMBB WTRUs/devices and URLLC WTRUs/devices.

eMBB data may be rate-matched around PSR 706 or 710 resources to ensure that the resources are not interfered. The PSR may be transmitted on one or more of an always-on short PUCCH, a configured short DTX interval, a set of dedicated PSR resources, or the like. After the SR has been sent, a URLLC WTRU, such as WTRU 102, or URLLC device may monitor for UL grants in DL virtual mini-slots within a given UL or DL normal slot. After allocation, the URLLC WTRU may transmit pre-emptive UL data in the link switched UL virtual mini-slot.

The gNB, such as any one of gNBs 180a, 180b, 180c, may inform a URLLC WTRU or URLLC device of what resources are configured or allocated for URLLC UL communications. A NR NodeB may also be substituted for a gNB. The resources may be the nearest UL virtual mini-slots or the nearest UL normal slot. A long time period may pass before the next UL virtual mini-slots or the next UL normal slot. To reduce latency, the gNB may dynamically change a DL virtual mini-slot to an UL virtual mini-slot, change a mini-slot to a UL/DL mini-slot, or overwrite a previous configuration. Similarly, the gNB may change a previously configured DL normal slot to an UL normal slot. The change may be signaled in a group-common PDCCH (or a common URLLC control channel) so that a plurality or most WTRUs (or most URLLC WTRUs) may be informed of the change. Such slots, in which the direction of the slot is changed pre-emptively, may be referred to as link-switched slots.

FIG. 10 is a process 1000 illustrating an example of pre-emptive link switching for URLLC UL communications in TDD. A URLLC WTRU or URLLC device may have data to transmit on the UL (1002). If communications are configured as grant free (1004), UL data may be transmitted or communicated pre-emptively in the next configured UL virtual mini-slot of a DL slot (1006) that is configured by a gNB. Without a grant free configuration, a request for pre-emptive uplink scheduling in a regular or normal slot may be transmitted by a URLLC WTRU or device (1008). If a gNB switches link direction from DL to UL for certain virtual mini-slots, a DL virtual mini-slot within a regular or normal UL/DL slot is monitored for UL grants (1010). If an uplink grant is received, pre-emptive UL data is transmitted or communicated in a link switched UL virtual mini-slot (1012).

Process 1000 may be performed when a positive acknowledgement (ACK) or PDCCH is not received for the grant free communication. A URLLC WTRU or URLLC device may try a fixed number of grant free communications and then switch to the schedule based communication. If an allocation is not sent for the schedule based communication, the URLLC WTRU may retry the PSR during the next PSR request resource. The request may also include information on the number of times the URLLC WTRU has attempted without receiving an allocation to enable the gNB to adjust the size of the PSR resources allocated to accommodate future demands.

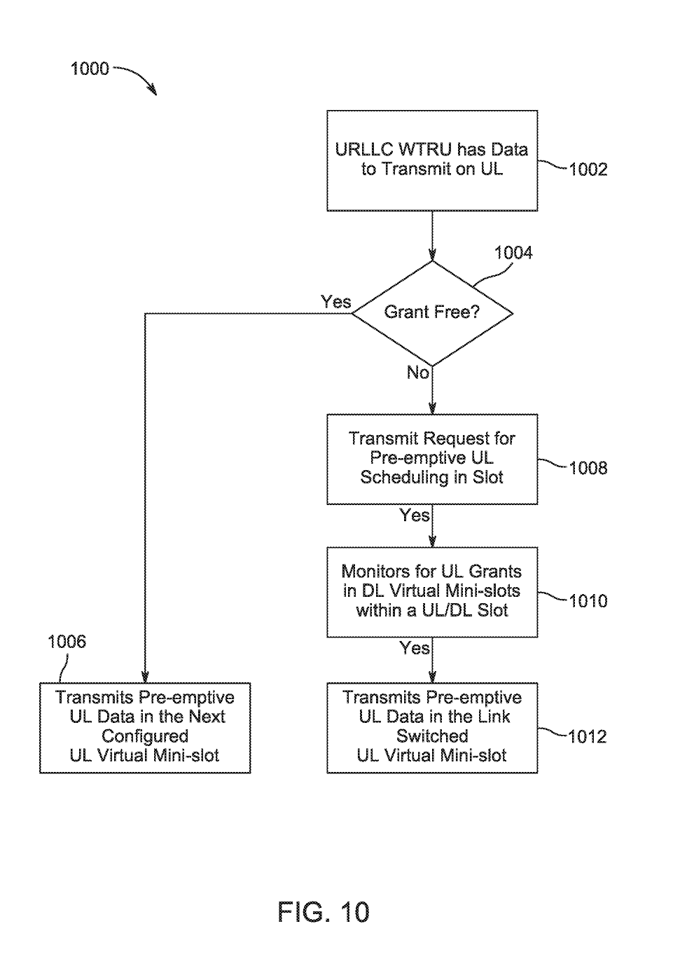

FIG. 11 is a signal diagram 1100 illustrating an example of UL eMBB communication pre-empted by an UL URLLC grant free communication. An eMBB WTRU, such as WTRU 102, or eMBB device may be transmitting or communicating traffic 1102 and can be pre-empted with data from an uplink URLLC grant-free communication in traffic 1104. Parts of traffic 1102 and 1104 may be substantially co-existing, concurrent, synchronized, simultaneous, or the like. In signal diagram 1100, a gNB may configure mini-slots as [UL, UL, DL, UL, UL, UL] in slot or time slot 1 with mini-slots 6 and 7 configured as grant-free resources. URLLC data 1108 may arrive in the 5^{th} mini-slot of slot or time slot 1. The URLLC WTRU or URLLC device may be configured as grant-free.

The URLLC WTRU may transmit data in mini-slot 6 and send a repetition in mini-slot 7. Transmission in mini-slot 6 or 7 may be at a higher transmit power or energy to ensure that it is decodable even with eMBB communication of traffic 1102. An eMBB WTRU or eMBB device may transmit utilizing minimum possible link parameters, power, modulation and coding scheme (MCS), code block group (CBG) size, or the like for the duration of slot 1 to ensure that if it is pre-empted, it may be able to recover some of communication and the URLLC WTRU data may also be decoded. An eMBB WTRU or eMBB device may also transmit or communicate with a lower link power for the duration of configured grant free mini-slots and transmit at a higher power level at other occasions.

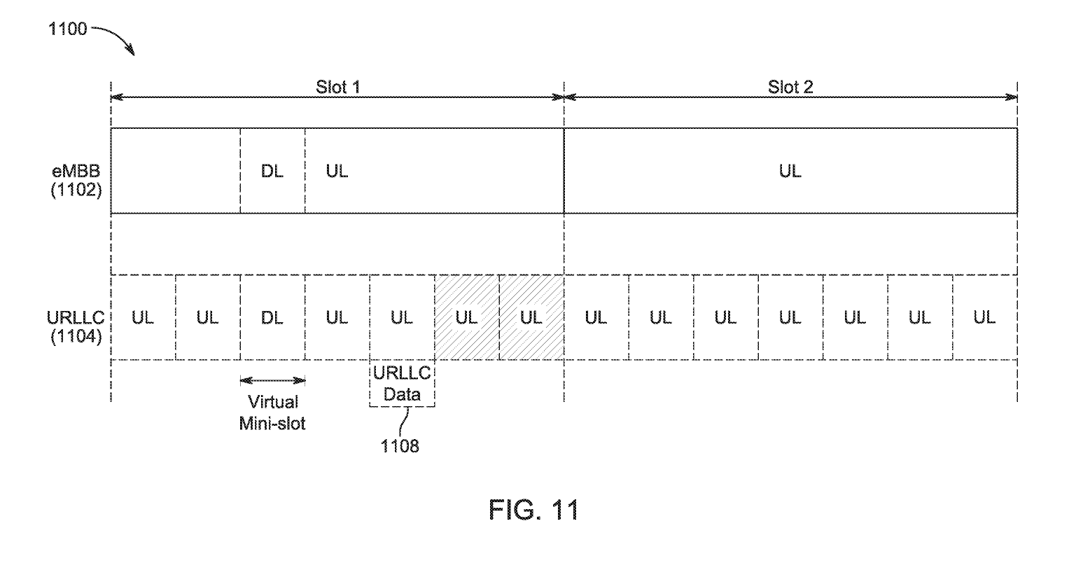

FIG. 12 is a signal diagram 1200 illustrating an example of UL eMBB communication pre-empted with an UL URLLC scheduled communication. An eMBB WTRU or eMBB device may transmit to the gNB, such as any one of gNBs 180a, 180b, 180c, traffic 1202 and be pre-empted with data from an uplink URLLC scheduled communication in traffic 1210. Parts of traffic 1202 and 1210 may be substantially co-existing, concurrent, synchronized, simultaneous, or the like. A NR NodeB may also be substituted for a gNB. A gNB may configure mini-slots as [UL, UL, DL/UL, UL, UL] in slot or time slot 1. URLLC data 1214 may arrive at or during the 4^{th} mini-slot of slot or time slot 1. The URLLC device may transmit an SR utilizing pre-configured PSR resources 1216 in the 5^{th} mini-slot. PSR resources 1204 or 1206 or SR resource 1208 may be reserved, configured, or pre-configured for both the URLLC WTRU and eMBB WTRU. The gNB may perform a link switch on the 6^{th} mini-slot to switch to a DL mini-slot. A URLLC control channel region 1218 may, as an example, be configured as a PDCCH that allocates the next mini-slot to the WTRU. WTRU may transmit data in or during the 7^{th} UL mini-slot.

A gNB may perform a link switch and switch the mini-slot to a UL/DL mini-slot. A URLLC control region may be transmitted in the DL section of the mini-slot and may allocate the UL section of the mini-slot to the WTRU. This may yield more efficient signaling and communication, and less latency. The URLLC control region may also function as an indicator to the eMBB WTRU, which may enable identification of the pre-empted resources and modification of its receiver to improve the possibility of the pre-empted data being decoded to reduce interference.

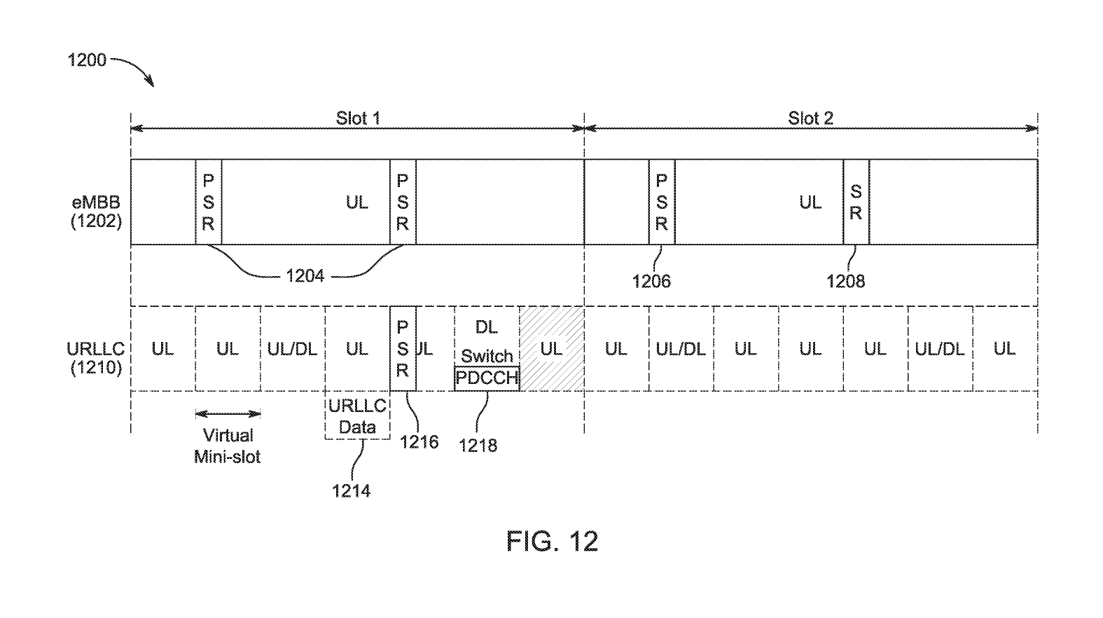

FIG. 13 is a signal diagram 1300 illustrating an example of a DL eMBB communication pre-empted by an UL URLLC grant free communication. A gNB, such as any one of gNBs 180a, 180b, 180c, transmitting a downlink signal in traffic 1302 to an eMBB WTRU, such as WTRU 102, or eMBB device may be pre-empted with data from an UL URLLC grant-free communication. A NR NodeB may also be substituted for a gNB. A gNB may configure mini-slots as [DL, DL, DL, DL, UL, UL, DL] in slot or time slot 1 with mini-slots 5, 6 and 7 configured as grant-free resources. Accordingly, a gNB may transmit to the eMBB WTRU during the DL mini-slot resources since it may be unable to listen and transmit at the same time. However, in a full-duplex receiver/transmitter/transceiver configuration, a gNB may attempt to transmit and receive at the same time. The gNB may also modify the DL communication of the eMBB WTRU by reserving a mini-slot for PSR 1304 or 1306 from a URLLC WTRU. URLLC data 1312 may arrive at or during the 4^{th} mini-slot of slot or timeslot 1 and the URLLC WTRU may be configured as grant-free. In traffic 1308, a URLLC WTRU may transmit data in mini-slot 5. Parts of traffic 1302 and 1308 may be substantially co-existing, concurrent, synchronized, simultaneous, or the like. In signal diagram 1300, since traffic 1302 is configured for eMBB downlink communication, higher power communication may be unneeded since the WTRU is not competing with another WTRU.

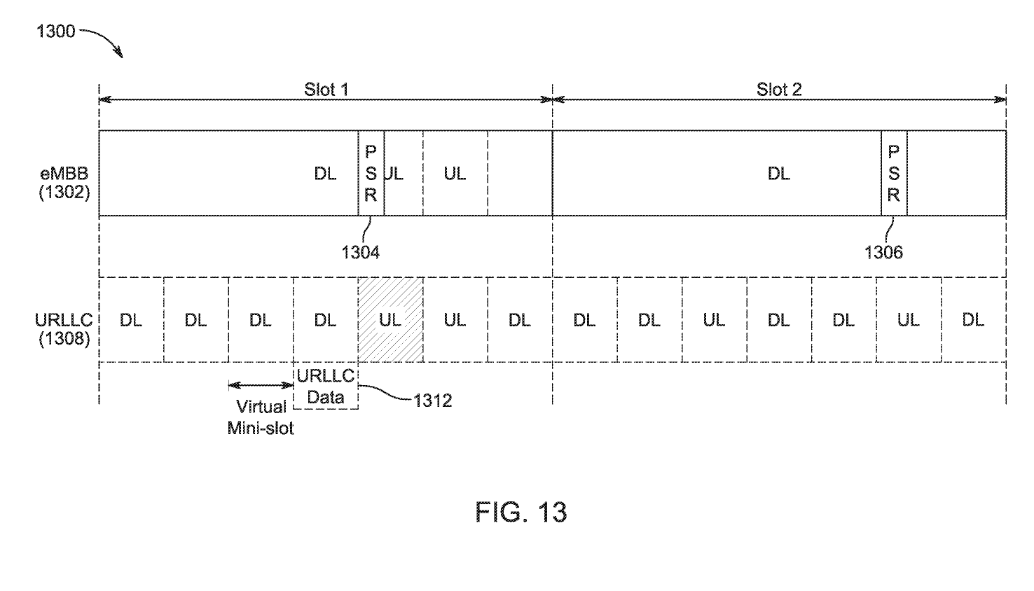

FIG. 14 is a signal diagram 1400 illustrating an example of a DL eMBB communication pre-empted by an UL URLLC scheduled communication. A gNB may link-switch a resource from DL to grant-free UL and inform WTRUs or devices of the switch by using a URLLC control channel in a prior downlink mini-slot. A gNB, such as any one of gNBs 180a, 180b, 180c, transmitting a downlink signal in traffic 1402 to an eMBB WTRU or eMBB device may be pre-empted with data from an uplink URLLC scheduled communication in traffic 1408. Parts of traffic 1402 and 1408 may be substantially co-existing, concurrent, synchronized, simultaneous, or the like. A NR NodeB may also be substituted for a gNB. A gNB may configure mini-slots as [DL, DL, DL, DL, UL, DL, UL] in slot or time slot 1. URLLC data 1412 may arrive at or during the 4^{th} mini-slot of slot or time slot 1. A URLLC WTRU or URLLC device may transmit a SR in the preconfigured PSR or SR resource 1407. PSR or SR resources 1404 and 1406 may be reserved for both the URLLC WTRU and eMBB WTRU. PSR resources for the eMBB WTRU may also be pre-emptive.

A URLLC control channel region 1414 may, as an example, be a PDCCH that allocates the next mini-slot, or the 7^{th} UL mini-slot, for communication. A URLLC control region may function as an indicator to the eMBB WTRU or eMBB device to enable to identify pre-empted resources. In response, the eMBB device receiver may improve the possibility of the pre-empted data being decoded.

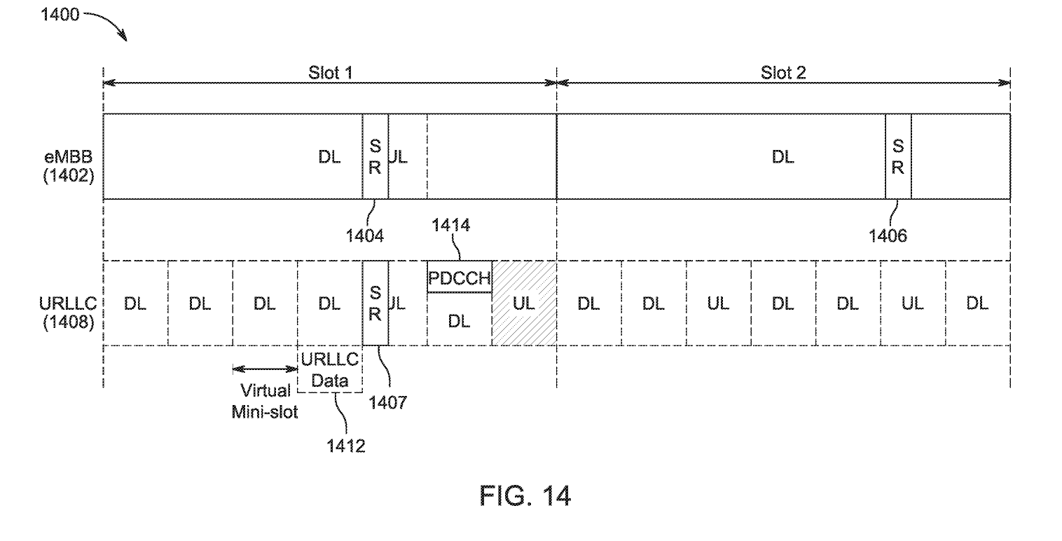

FIG. 15 is a signal diagram 1500 illustrating an example of a DL eMBB communication pre-empted with uplink URLLC scheduled/grant based communication. A gNB, such as any one of gNBs 180a, 180b, 180c, transmitting a downlink signal in traffic 1501 to an eMBB WTRU or eMBB device may be pre-empted with data from an uplink URLLC communication in traffic 1508. Parts of traffic 1501 and 1508 may be substantially co-existing, concurrent, synchronized, simultaneous, or the like. A NR NodeB may also be substituted for a gNB. The URLLC communication is scheduled but may fall back to a grant free communication if it does not receive a DL scheduling signal from the gNB.

In signal diagram 1500, a gNB is transmitting DL information to the eMBB WTRU, such as WTRU 102, or eMBB device illustrated by the 2 DL slots. The gNB may configure mini-slots for URLLC communication as [DL, DL, UL, DL, UL, DL, UL] in slot or time slot 1. The gNB may configure pre-determined or scheduled resources 1502, 1510, 1514, and 1520 for PSRs to enable the URLLC WTRU to request for data if it has data to send in the uplink. These PSR resources may be reserved for both eMBB and URLLC WTRUs, with the gNB communicating these resources to the eMBB WTRU using a configuration mechanism such as L1, L2 or L3 signaling. An UL packet 1512 may arrive in traffic 1508 at a mini-slot. A PSR may be communicated using resource 1514. An UL grant 1516 may be received on the PDCCH to transmit UL data 1518 in dynamically pre-empted resources 1504 in the 7^{th} mini-slot.

In signal diagram 1500, PDCCH 1506 may be utilized to indicate pre-emption to an eMBB WTRU or device for both UL or DL URLLC transmissions or communications. In addition, if a PDSCH communication (not shown) overlaps with resources indicated by the PSR, a gNB may rate match PDSCH communications around each configured PSR resource.

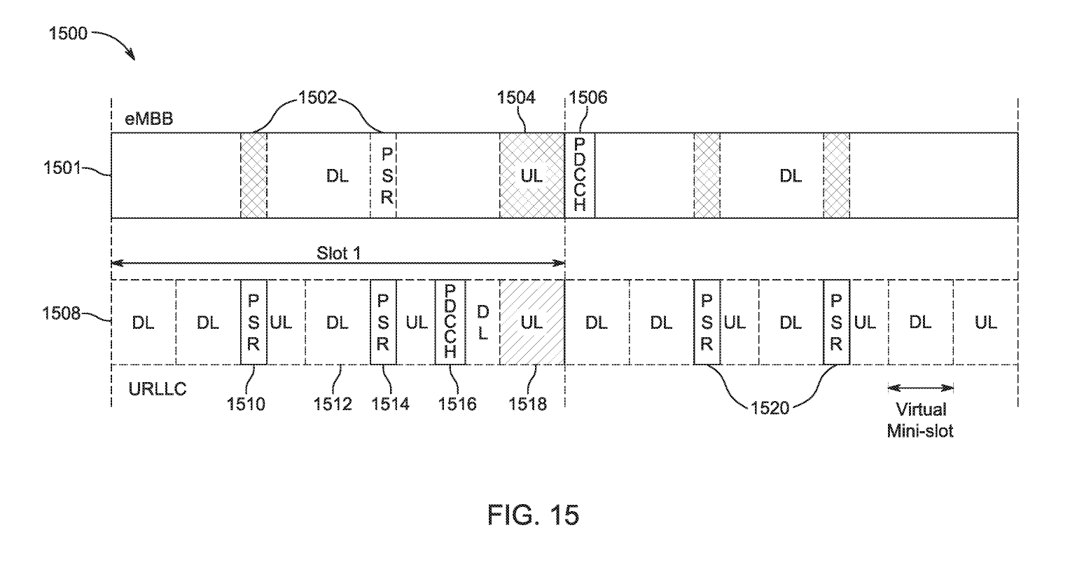

FIG. 16 is a process 1600 which illustrates an exemplary procedure by an eMBB WTRU, such as WTRU 102, or eMBB device. An eMBB WTRU may receive resource scheduling configuration information from the gNB, such as any one of gNBs 180a, 180b, 180c, for a PSR (1602). A NR NodeB may also be substituted for a gNB. PSRs may be configured with respect to DL resources for eMBB communications. If the PDSCH communication overlaps with the resources indicated by the PSR, the eMBB WTRU may decode the PDSCH communication resources rate matched by the gNB (1604). In slots that contain a configured PSR, the eMBB WTRU may monitor a PDCCH (PDCCH1) for a DCI carrying an UL pre-emption indication, indicating that there are dynamic pre-empted resources for UL URLLC data communication in a slot (1606).

Moreover, a eMBB WTRU may search for a URLLC UL grant in a DCI, such as on a second PDCCH or PDCCH2, to identify the specific pre-empted resources in the DL configured mini-slots or the DL configured mini-slot indicated in PDCCH1. An indication on a control channel may also communicate the specific resources pre-empted. If the UL pre-emption indication is received, an eMBB WTRU may follow a pre-emption procedure (1608). The eMBB WTRU may identify the specific resources pre-empted and modify decoding procedure to take into account the pre-empted resources. If the gNB is able to dynamically rate match around dynamically pre-empted resources, the eMBB WTRU may also adjust decoding procedure to rate match around the indicated resources for proper decoding. If the gNB is unable to dynamically rate match around the pre-empted resources, the eMBB WTRU procedure may ignore the resource during decoding assuming that the DL communication is punctured for that duration. A pre-emption procedure may also be similar to that provided for a DL pre-emption indication with respect to detection of a PDSCH.

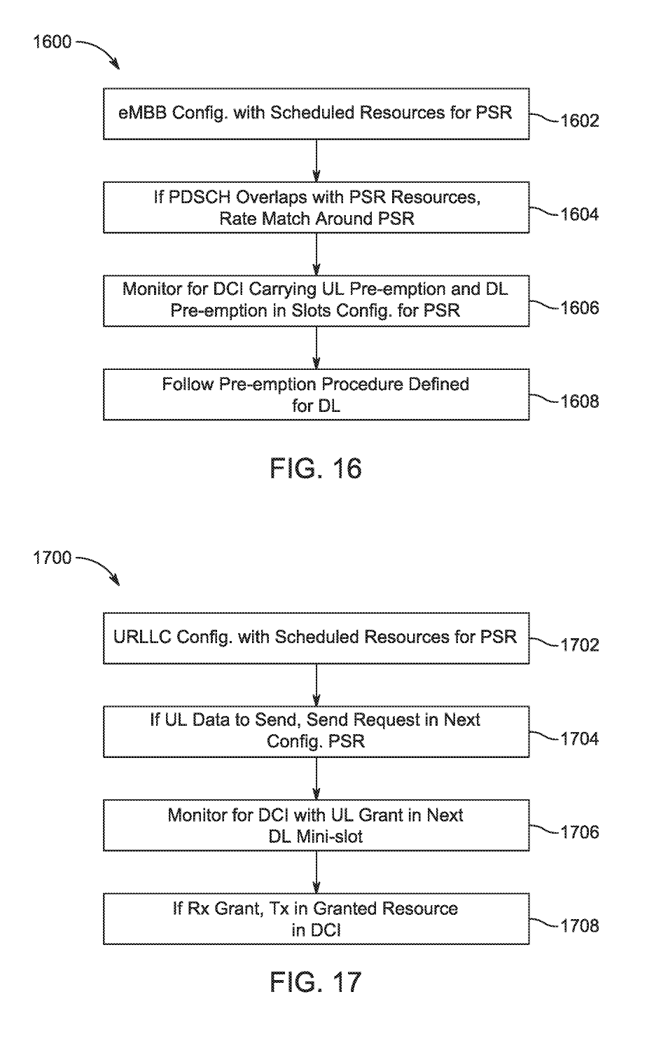

FIG. 17 is a process which illustrates an exemplary procedure 1700 by an URLLC device, such as WTRU 102. The URLLC WTRU may receive resource scheduling configuration information from the gNB, such as any one of gNBs 180a, 180b, 180c, for a PSR (1702). A NR NodeB may also be substituted for a gNB. The configuration may be with respect to UL resources. If URLLC data arrives at the WTRU for communication, the WTRU may transmit a request, such as a scheduling request, on the next available resource configured for the PSR (1704). The configuration may be such that the PSR resource occurs every mini-slot or once every few mini-slots, a staggered arrangement, etc. depending on the amount of URLLC traffic available, latency, the amount of overhead required, or the like. A URLLC device may begin monitoring a PDCCH, such as a PDCCH2, for a DCI carrying an UL grant in the next configured DL mini-slot following the PSR communication (1706). The UL mini-slot may be the next UL mini-slot with configured grant-free resources after a DL mini-slot in which the WTRU monitors for the DCI carrying the UL grant. If a grant is received, the URLLC WTRU may transmit on the resources indicated in control information, such as DCI (1708). Without a grant, the URLLC WTRU may transmit in a configured grant free resource in the next available UL mini-slot.

For beam based communication, a PSR configuration may also include information that indicates receive beams that will be set at the gNB during each PSR resource. Different beams may impact WTRUs that may be eligible to send a PSR at that time. In beam based communication, STAs that are members of a group that can be received by a specific beam(s) may transmit during the PSR. In certain configurations, only the receive beam information may be sent. In certain configurations, a list of eligible STAs or STA group information may be sent. In addition, a gNB may sweep through all or a subset of receive beams within each PSR duration.

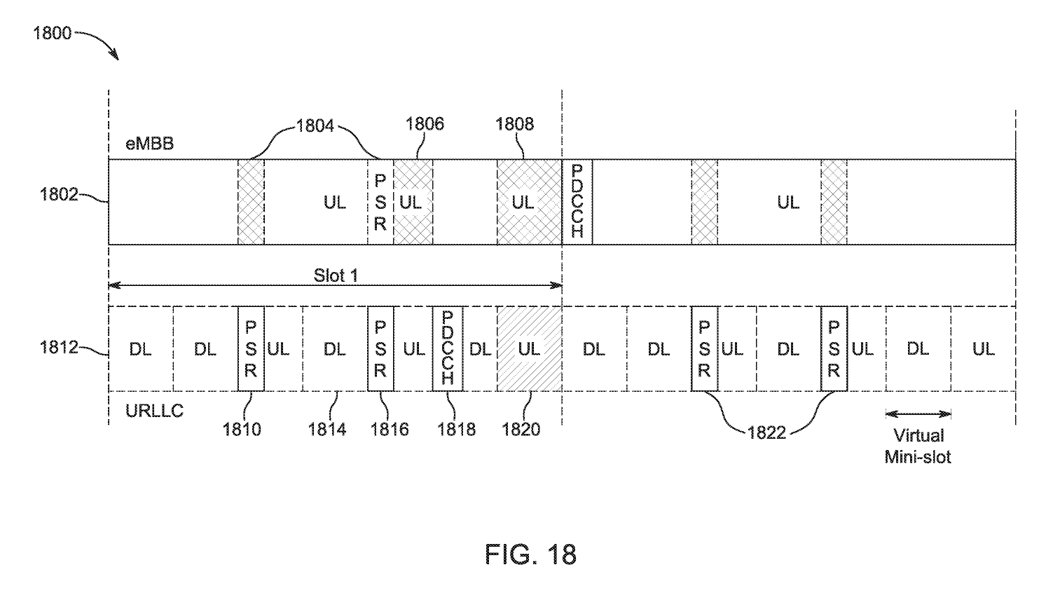

FIG. 18 is a signal diagram 1800 illustrating an example of an UL eMBB communication with UL URLLC pre-emption and reserved URLLC pre-emption mini-slots. An eMBB WTRU, such as WTRU 102, or eMBB device may be transmitting uplink signals in traffic 1802 to a gNB and is pre-empted with data by an uplink URLLC communication in traffic 1812. Parts of traffic 1802 and 1812 may be substantially co-existing, concurrent, synchronized, simultaneous, or the like.

When a URLLC communication is scheduled, a fall back to a grant free communication may be performed if a scheduling grant or signal is not received. eMBB WTRU or eMBB device may be transmitting UL information to the gNB, such as any one of gNBs 180a, 180b, 180c, illustrated by the 2 UL slots. A NR NodeB may also be substituted for a gNB. The gNB may configure mini-slots for URLLC communication as [DL, DL, UL, DL, UL, DL, UL] in slot 1 and the second slot. For eMBB slot 1, the 1^{st} symbol of the slot may be set to downlink communication to allow for communication of pre-emption indications to the eMBB WTRU.

The gNB may configure pre-determined or scheduled resources 1804, 1810, 1816, or 1822 for PSRs. There resources may enable the URLLC WTRU to request a grant in the case that it has data to send in the uplink. These PSR resources may be reserved for both the eMBB and URLLC WTRUs, with the gNB communicating these resources to the eMBB WTRU using a configuration mechanism such as L1, L2 or L3 signaling. If a PDSCH communication overlaps with the resources indicated by the PSR, the WTRU may rate match PDSCH communications around the PSR resource for decoding.

In signal diagram 1800, an UL packet 1814 may arrive in traffic 1812 at or during the 4^{th} mini-slot. A PSR may be communicated using resource 1816 during pre-empted UL resources 1806. An UL grant 1818 may be received on the PDCCH to transmit UL data 1820 in pre-empted resources with power rate adjustment 1808 in the 7^{th} mini-slot.

The gNB may configure pre-emptive mini-slot resources to transmit UL URLLC data and DL URLLC data. These pre-emptive mini-slot resources may be a fixed set of configured mini-slots after a PSR resource. Setting or defining pre-emptive mini-slot resources may allow the eMBB WTRU or eMBB device to determine when a possible pre-emption may take place and to modify communication if needed. The eMBB WTRU may modify communication parameters within pre-emptive resources to accommodate possible interference by a simultaneously transmitting URLLC WTRU. These modifications may include reducing transmit power, reducing the MCS, or modifying CBG size to allow for more granularity in retransmissions. In certain configurations, the WTRU may also stop communication within these resources.

The next slot after a PSR may comprise a PDCCH with pre-emptive indications of UL/DL URLLC pre-emption. In the UL eMBB communication scenario, this may be used by the eMBB WTRU to identify if a failure was due to a pre-emption or a link failure and used to improve link adaptation algorithms, such as open loop link adaptation.

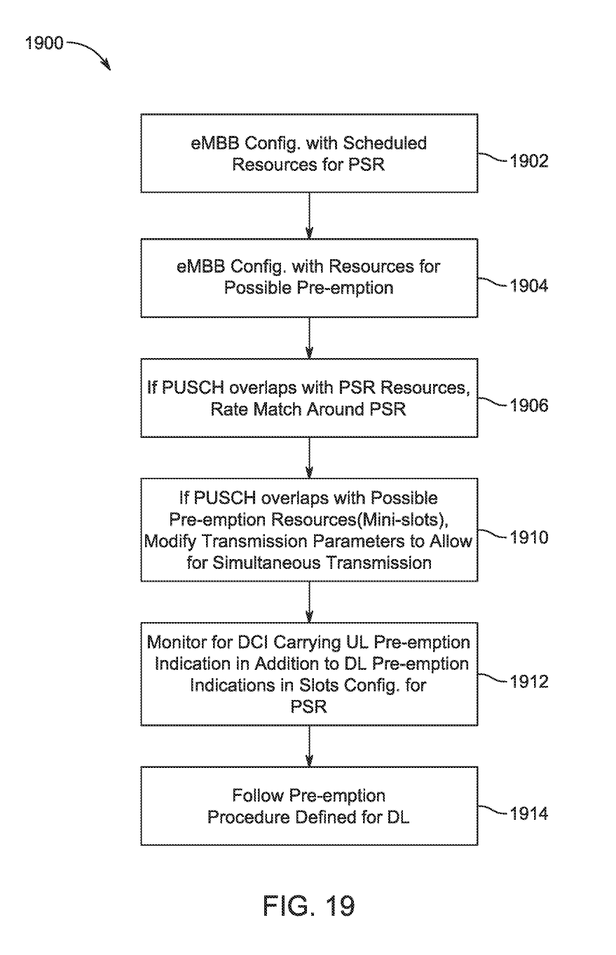

FIG. 19 is an exemplary process 1900 performed by an eMBB device. An eMBB device may receive configuration information for scheduling resources for one or more PSRs (1902). The eMBB device may also receive configuration information for resources for possible pre-emption (1904). If an UL transmission or physical uplink shared channel (PUSCH) overlaps with PSR scheduled resources, rate matching may be utilized around, before, or after the PSR (1906) by the eMBB device. If a PUSCH or UL shared channel overlaps with potential or possible resources for pre-emption, such as mini-slots or short slots, the eMBB device may modify transmission, receive, or communication parameters to allow for simultaneous transmission (1910) or communications. The gNB may indicate these parameters to enable the eMBB device to transmit reliably even with the communication or transmissions by the eMBB device. Such parameters may include transmission power, power control, increased repetition, specific beam communication, or the like.

The eMBB device may monitor for downlink control signaling or a DCI carrying an indication for UL pre-emption in addition to DL pre-emption indications in slots configured for PSR (1912). The eMBB device may subsequently follow the pre-emption procedure configured or defined for the DL.

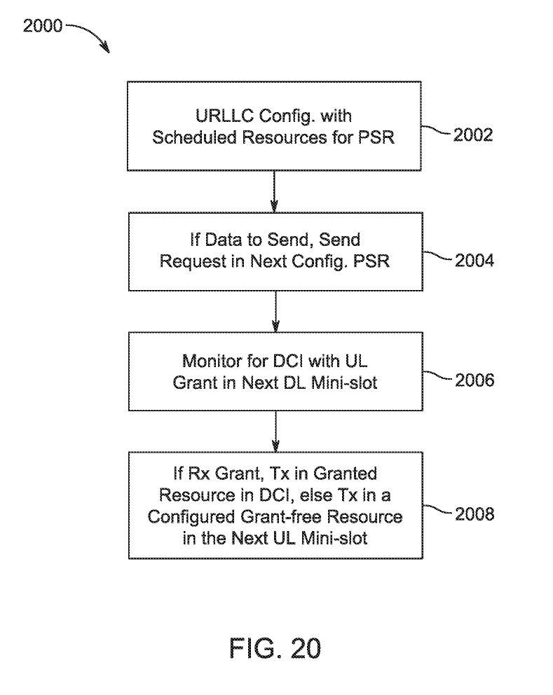

FIG. 20 is an exemplary process 2000 performed by an URLLC device. An URLLC device may receive configuration information for pre-configuring scheduling resources for one or more PSRs (2002). On arrival of UL URLLC data to send, an URLLC WTRU or URLLC device may send a request, such as a scheduling request, in the next configured PSR (2004). The URLLC WTRU may listen or monitor for an UL grant in the next DL mini-slot in downlink control signaling, such as a DCI (2006). The control information with the URLLC UL grant may be communicated on a PDCCH. The gNB may stop listening to the communication from the eMBB WTRU during this time period. In such a configuration, sending an indication to the eMBB WTRU may be desirable for context and awareness.

If a grant is received, the URLLC WTRU may transmit to the gNB in the granted or allocated resources specified by the UL grant in the DCI. If a grant is not received, transmission in a configured grant-free resource, if available, in the next UL mini-slot may be performed (2008). Transmission, reception, or communication parameters may also be modified to allow for simultaneous transmission or communication between the URLLC WTRU and eMBB device. The gNB may indicate parameters to enable the URLLC WTRU to transmit reliably even with the communication or transmissions by the eMBB WTRU. Such parameters may include transmission power, power control, increased repetition, specific beam communication, or the like.

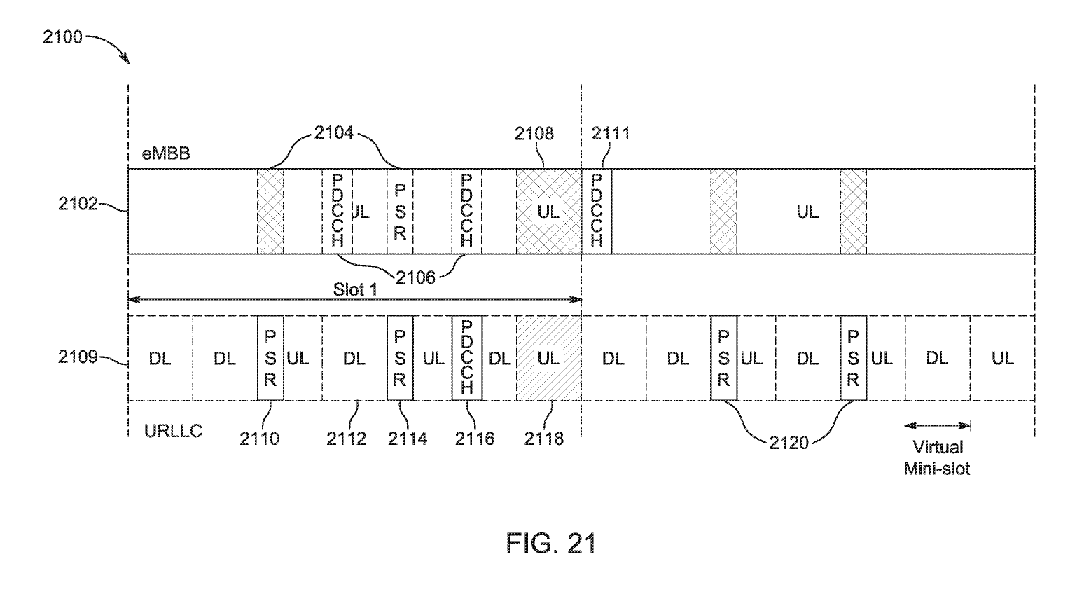

FIG. 21 is a signal diagram 2100 illustrating an example of configuring dynamic UL pre-emptive indications. A gNB, such as any one of gNBs 180a, 180b, 180c, may configure pre-determined or scheduled PSR resources 2104, 2110, 2114, and 2120 to enable a URLLC WTRU, such as WTRU 102, or URLLC device to be able to request for resources to send data in the uplink. A NR NodeB may also be substituted for a gNB. These PSR resources may be reserved for both the eMBB and URLLC WTRUs, with the gNB communicating these resources to the eMBB WTRU using a configuration mechanism such as L1, L2 or L3 signaling. If a PDSCH communication (not shown) overlaps with the resources indicated by a PSR, a WTRU may rate match PDSCH communications around the PSR resource for decoding.

A gNB may configure pre-emptive PDCCH resources 2106 or 2116 for UL URLLC indication or UL grants, respectively, in traffic 2102 or 2109. Parts of traffic 2102 and 2109 may be substantially co-existing, concurrent, synchronized, simultaneous, or the like. These are resources in which UL URLLC indication or grants may be transmitted to identify resources for pre-emptive UL or DL URLLC data communication. These pre-emptive indications or grants may be at a fixed time-frequency resource after PSR resource 2104 or 2114. The fixed resource(s) may be pre-determined or set up by configuration.

In signal diagram 2100, an UL packet 2112 may arrive in traffic 2109 at or during the 4^{th} mini-slot. A SR may be communicated using PSR resource 2114. An UL grant may be received on the PDCCH to transmit UL data 2118 in dynamically pre-empted resources for URLLC traffic 2108 in or during the 7^{th} mini-slot.

Communicating dynamic pre-emption indications on PDCCH 2106 or 2111 may allow an eMBB WTRU or eMBB device to determine when a pre-emption will take place and to modify communication accordingly. In addition, an eMBB WTRU may decode a URLLC grant, such as UL grant. A dedicated eMBB indication of a URLLC grant may also be sent from a gNB to the eMBB WTRU rather than the eMBB WTRU needing to decode the signal meant for the URLLC WTRU for pre-emption interference or noise management.

To optimize the decoding process, the eMBB WTRU may use energy detection within a resource to identify whether there is UL pre-emption. If the eMBB WTRU is able to identify the specific pre-empted resource from the signal, the location of the pre-empted resource relative to the indication may be dynamic. If the eMBB WTRU is unable to identify the specific pre-empted resource from the signal, a fixed relationship between the indication and the resource to be pre-empted may be desired. Similar to other configurations given herewith, if a PDSCH communication overlaps with the indication resources, the WTRU may rate match PDSCH communication around the resource for decoding.

In signal diagram 2100, an eMBB WTRU may modify communication parameters within pre-emptive resources to accommodate possible interference or noise by a simultaneously transmitting URLLC WTRU. Modifications may include reducing the transmit power, reducing the MCS, modifying CBG size, or the like to allow for more granularity in retransmissions.

As described herewith, in certain configurations the next slot after a PSR may comprise a PDCCH with pre-emptive indications of UL/DL URLLC pre-emption. In the UL eMBB communication scenario, this may be used by the eMBB WTRU to identify if a failure was due to a pre-emption or a link failure. This determination may improve link adaptation algorithms, such as in an open loop link adaptation.

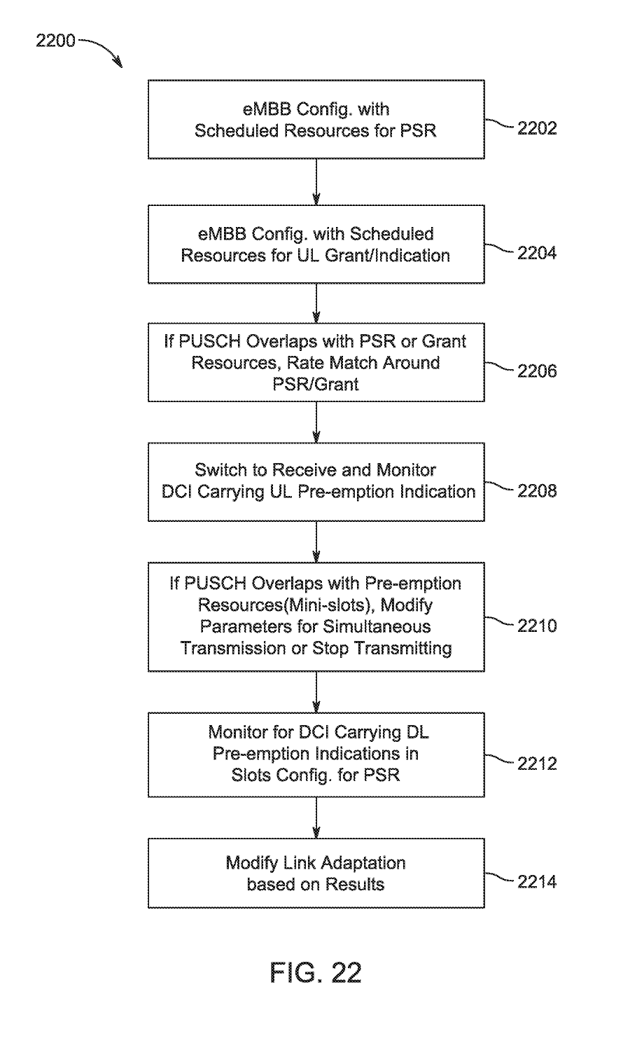

FIG. 22 is an exemplary process 2200 performed by an eMBB device. An eMBB device may receive configuration information for pre-configuring scheduling resources for one or more PSRs (2202). An eMBB device may also be configured with scheduled resources to receive an UL grant or indication related to pre-emption of URLLC data (2204). If a PUSCH or UL shared channel overlaps with a PSR or granted resources, rate matching may be utilized around the PSR or scheduling grant by the eMBB device (2206). The eMBB device may switch to receive or monitor for an UL pre-emption indication in downlink control signaling, such as a DCI (2208). The gNB may stop listening to the communication from the eMBB WTRU during this time period. In such a configuration, sending an indication to the eMBB WTRU may be desirable for interference or noise management.

If a PUSCH or UL shared channel overlaps with pre-emption resources, such as mini-slots, the eMBB device may modify transmission, receive, or communication parameters to allow for simultaneous transmission (2210) or communication. It is noted that the gNB may indicate these parameters to enable the eMBB WTRU to transmit reliably even with the communication or transmissions by the eMBB WTRU. Such parameters may include transmission power, power control, increased repetition, specific beam communication, or the like.

The eMBB device may monitor for DCI carrying an indication for DL pre-emption in slots configured for PSR (2212). While monitoring, an eMBB device may use link adaptation and modify link adaptation procedures based on process 2200 to reduce link failure. The eMBB device may subsequently follow the pre-emption procedure configured for the DL.

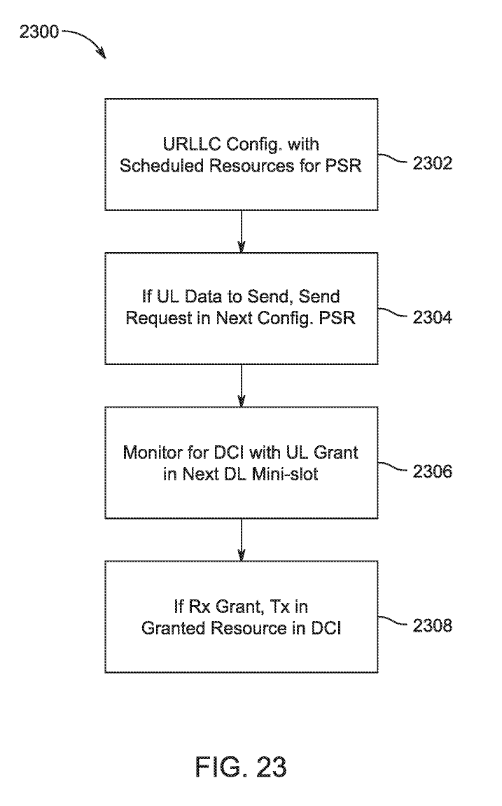

FIG. 23 is an exemplary process 2300 performed by an URLLC device. An URLLC device may receive configuration information for pre-configuring scheduling resources for one or more PSRs (2302). On arrival of UL URLLC data to send, an URLLC WTRU or URLLC device may send a request, such as a SR, in the next configured PSR (2304). The URLLC WTRU may listen or monitor for an UL grant in the next DL mini-slot in downlink control signaling, such as a DCI (2306). The control information with the URLLC UL grant may be communicated on a PDCCH.

If an UL scheduling grant is received, the URLLC WTRU may transmit to the gNB in the granted or allocated resources specified by the UL grant in the downlink control signaling. If a grant is not received, transmission in a configured or pre-configured grant-free resource in the next UL mini-slot may be performed (2308). The eMBB device may modify transmission, receive, or communication parameters to allow for simultaneous transmission or communication. The gNB may indicate parameters to enable the URLLC WTRU to transmit reliably even with the communication or transmissions by the eMBB WTRU. Such parameters may include transmission power, power control, increased repetition, specific beam communication, or the like.

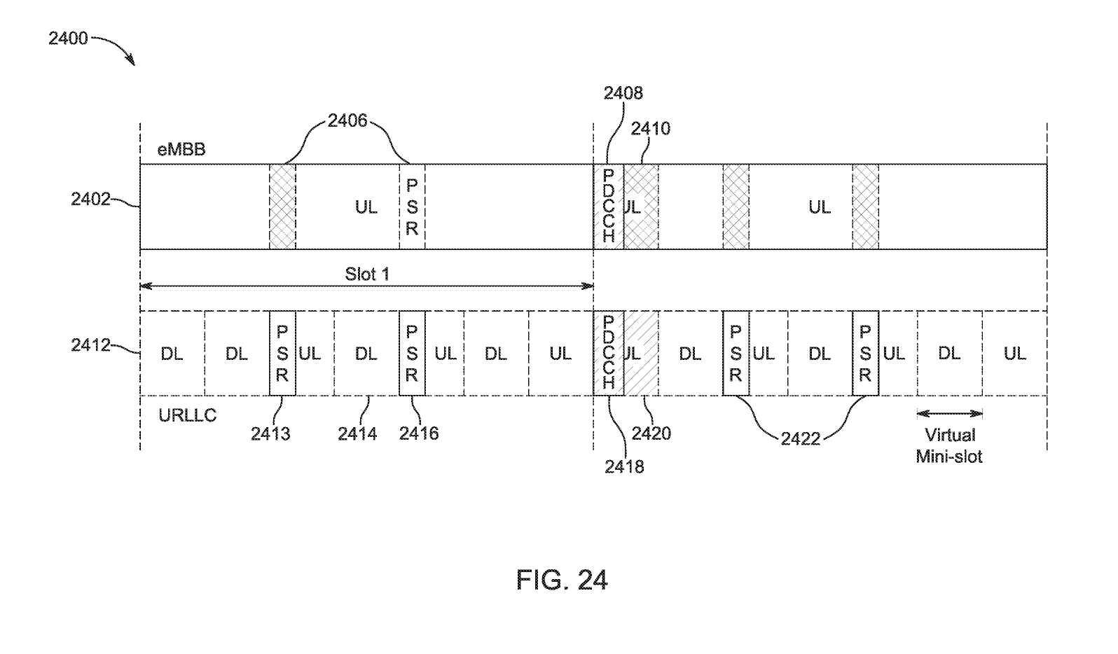

FIG. 24 is a signal diagram 2400 illustrating an example of a URLLC WTRU that is requested by a gNB to wait for a grant. A URLLC WTRU or URLLC device is requested by the gNB, such as any one of gNBs 180a, 180b, 180c, to wait until the next slot for an uplink grant. While waiting, the eMBB WTRU or eMBB device may maintain configured operations or procedures. A NR NodeB may also be substituted for a gNB. Traffic 2402 may be configured for eMBB communications and traffic 2412 for URLLC communications. Parts of traffic 2402 and 2412 may be substantially co-existing, concurrent, synchronized, simultaneous, or the like. A gNB may configure pre-determined or scheduled resources for PSRs 2406, 2413, 2416, and 2422 to enable a URLLC WTRU, such as WTRU 102, or URLLC device to be able to request for resources to send data in the uplink.

In signal diagram 2400, an UL packet 2414 may arrive in traffic 2412 at or during the 4^{th} mini-slot. A SR may be communicated using PSR resource 2416. An UL grant 2418 may be received on the PDCCH to transmit UL data 2420. Meanwhile, pre-emption indications on PDCCH 2408 for UL and DL may be sent on dynamically pre-empted resources 2410.

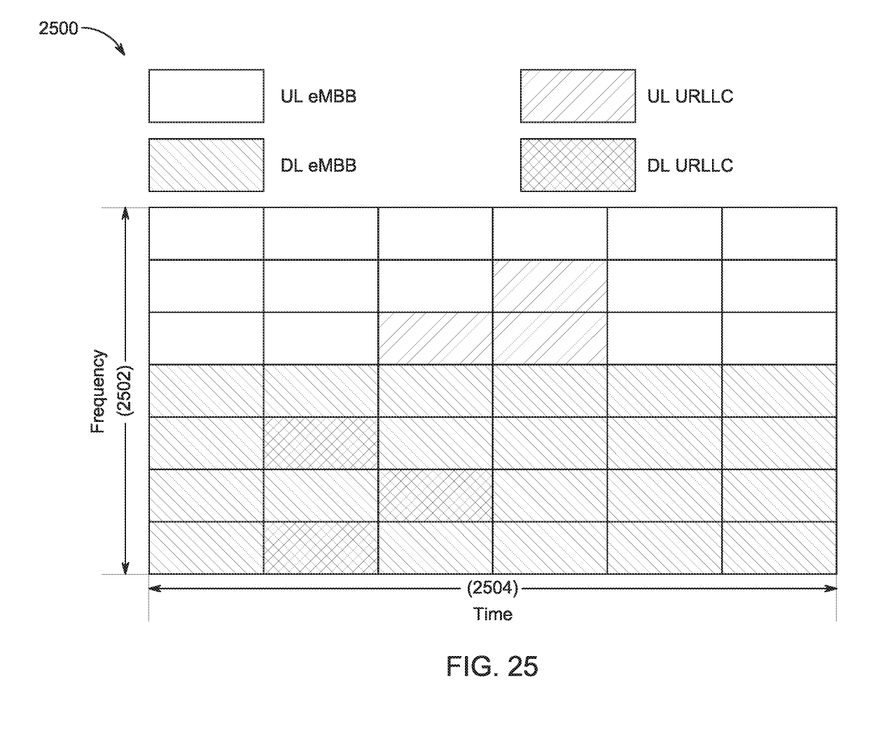

Any of the examples or embodiments given herewith for TDD may be adapted, applied, or configured for FDD. FIG. 25 is a signal diagram 2500 illustrating an example of resource allocation by a FDD gNB for pre-empting URLLC communication. URLLC and eMBB communications may be multiplexed in a FDD communication mode over frequency resources 2502 and time 2504. During the communication of eMBB traffic UL eMBB or DL eMBB, URLLC traffic may arrive. The URLLC communication of UL URLLC information or DL URLLC information may pre-empt eMBB data in the direction of communication, such as UL or DL. Pre-emption over one or more resources may include superposition or puncturing.

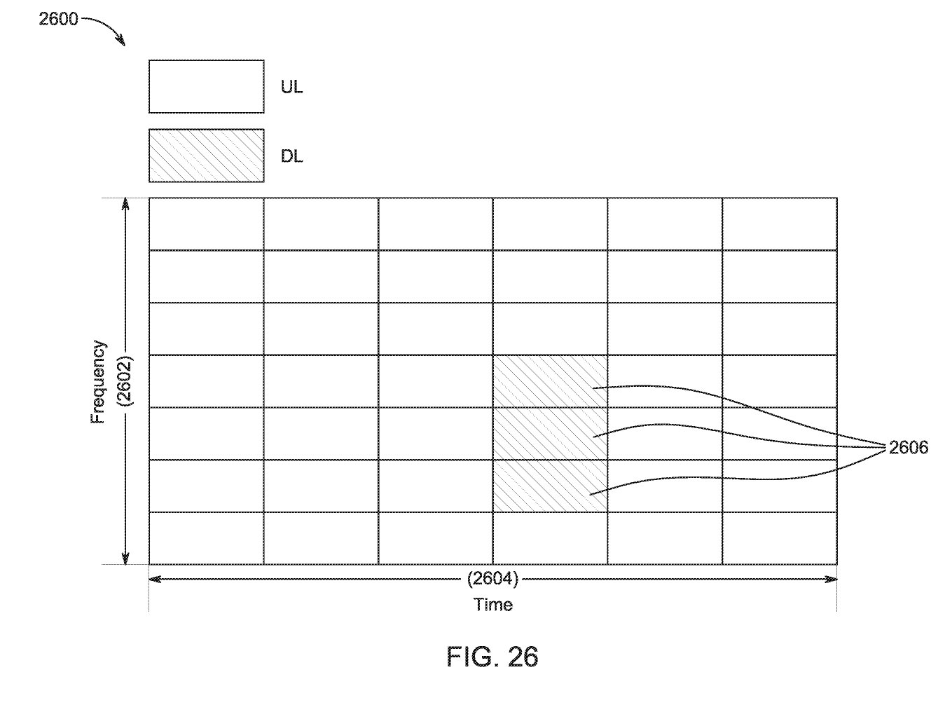

FIG. 26 is a signal diagram 2600 illustrating an example of full-duplex gNB resource allocation in an UL time slot for DL URLLC communications. Frequency resources 2602 and time resources 2604 may be allocated for the UL and DL. If a gNB operates in a full-duplex mode, or the gNB is capable of simultaneously transmitting and receiving in the same frequency band, disruption to UL communications may be minimized by optimized scheduling. In signal diagram 2600, a gNB may identify resources not used for UL communication, and use these resources for DL URLLC communication. The selection of the unused UL resources may be made to minimize self-interference at the gNB. In signal diagram 2600, unused resources 2606 may be used for DL URLLC communication.

Certain configurations may be used where subcarrier spacing or SCS of eMBB communication is greater than, less than, or equal to that of URLLC communication. SCS may change symbol duration T and numerology based on 1/SCS. eMBB signal numerology may also be adapted by matching sub-carrier spacing of an eMBB signal to that of inserted URLLC communication numerology and switching back to native numerology otherwise. Such inserted URLLC communication numerology may be inserted using super-position or similar techniques.

A dynamic change of eMBB SCS within a slot or mini-slot may be desired to switch numerology. A guard time may be used at transitions to allow the eMBB WTRU to settle with the new SCS. A cyclic prefix (CP) of eMBB communication may also be matched to that of the URLLC communication for sub-carrier level alignment in addition to time-domain symbol level matching of eMBB and URLLC data. This may allow utilization of a successive interference cancellation (SIC) by a receiver or transceiver rather than advanced interference cancellation schemes. In addition, in the examples or embodiments given herewith, sub-carriers for reference signals may be punctured for improved quality channel estimation. Puncturing may results in eMBB power=0.

A scalable numerology for NR may be desired and achieved with URLLC sub-carrier spacing set as an integer multiple of the eMBB SCS. As an example, an eMBB communication may use LTE SCS of 15 kHz while the URLLC communication may use a sub-carrier spacing of 60 kHz. Numerology, such as at 15 kHz spacing, of eMBB communication may be maintained but data or control information may be assigned on non-adjacent sub-carriers at the appropriate spacing, such as at one in every four sub-carriers at 60 kHz. Zeros may be inserted into skipped sub-carriers. This may result in a repetition in the time domain which may be truncated to a suitable time length. This approach may be suitable for scenarios in which the eMBB communication sub-carrier spacing is less than that of the URLLC communication. Sub-carrier spacing of URLLC communication may also be modified to match that of eMBB communication. This may be suitable for scenarios in which eMBB communication has a sub-carrier spacing larger than that of URLLC communication.

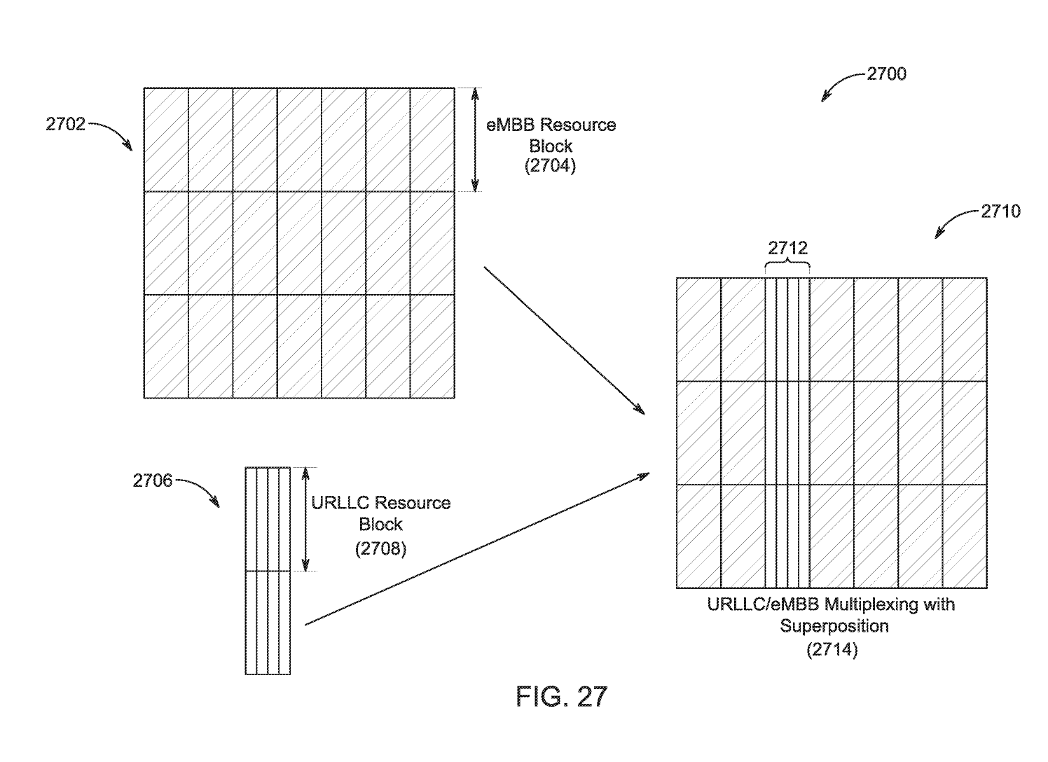

FIG. 27 is a signal diagram 2700 illustrating an example of URLLC traffic insertion across less resource blocks than eMBB communications. eMBB resources 2702 may have eMBB resource block size 2704. URLLC resources 2706 may have URLLC resource block size 2708. With URLLC and eMBB multiplexing with superposition 2714, URLLC communication 2712 may be assigned fewer frequency resource blocks than that of the eMBB communication in resources 2710. In addition, for signal diagram 2700 numerology of eMBB communication may be changed across an assigned frequency bandwidth to match numerology of the URLLC communication. For instance, sub-carrier spacing of eMBB communication may be configured to be greater than, less than, or equal to that of URLLC communication.

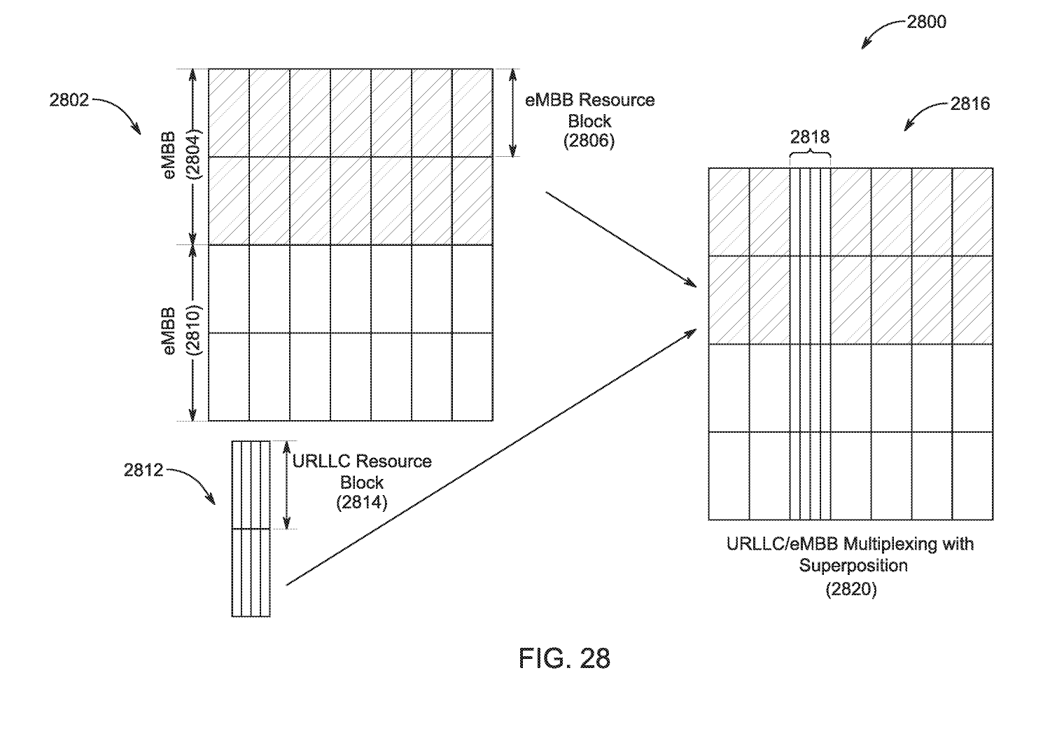

FIG. 28 is a signal diagram 2800 illustrating an example of URLLC traffic insertion across multiple eMBB devices. eMBB resources 2802 may have eMBB resource block size 2806 for eMBB device 1 resources 2804 and eMBB device 2 resources 2810. URLLC resources 2812 may have URLLC resource block size 2814. With URLLC and eMBB multiplexing with superposition 2820, URLLC communication 2818 may be assigned fewer frequency resource blocks than that of the eMBB communication for eMBB device 1 and eMBB device 2 in resources 2816. In this configuration, URLLC communication is assigned a number of frequency resource blocks that span across multiple eMBB devices. In addition, when URLLC assigned frequency resources partially overlap with resource blocks of multiple eMBB devices, numerology of the eMBB communication may be changed for the assigned frequency bandwidth for affected eMBB devices to match the numerology of the URLLC.

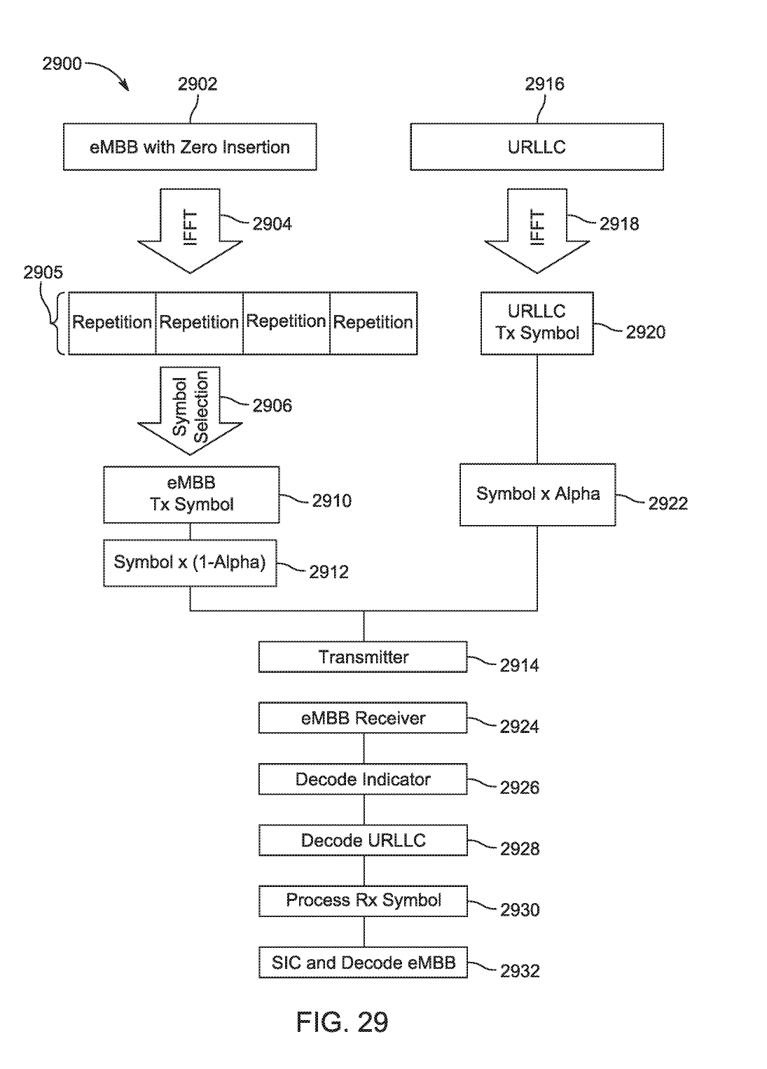

FIG. 29 is a process 2900 illustrating an example of eMBB and URLLC multiplexing with dynamic eMBB numerology. An eMBB communication with zero insertion may be initiated by the gNB 2902 and signaled for iFFT processing 2904. Although any SCS may be utilized, a 15 kHz SCS numerology may be utilized for the eMBB communication. URLLC data may arrive at the gNB for transmission 2916 and signaled for iFFT processing 2918. The URLLC data communication may be encoded with a 60 kHz numerology. In an illustration, an exemplary URLLC data input sequence of [a1 b1 c1 d1] may be processed by a 4 point FFT.

A gNB, such as any one of gNBs 180a, 180b, 180c, may modify numerology to match the numerology of the URLLC data. For instance, a gNB may continue communication at 15 kHz but with 4×zero insertion between samples for eMBB data. A NR NodeB may also be substituted for a gNB. Repetition 2905 and symbol selection 2906 processing may be utilized to generate eMBB transmission symbol 2910.

Moreover, an exemplary eMBB data input sequence may be [w1 x1 y1 z1 w2 x2 y2 z2 w3 x3 y3 z3 w4 x4 y4 z4] and processed by a 16 point FFT. This sequence may be split into 4 sequences given by [w1 0 0 0 x1 0 0 0 y1 0 0 0 z1 0 0 0]; [w2 0 0 0 x2 0 0 0 y2 0 0 0 z2 0 0 0]; [w3 0 0 0 x3 0 0 0 y3 0 0 0 z3 0 0 0]; [w4 0 0 0 x4 0 0 0 y4 0 0 0 z4 0 0 0]. Each sequence may be processed by a 16 point FFT independently. The 16 point time domain output for each sequence may be a periodic sequence repeated 4 times and as such, the first 4 time domain symbols may be transmitted without any significant loss of information. This may match the URLLC data numerology at 60 kHz.

Power of URLLC transmit symbol 2920 data or control information may be determined by multiplication or scaling of an Alpha parameter 2922. Power of eMBB data or control information may be multiplied or scaled by 1−Alpha 2912. For a certain configuration, alpha>0.5 may be configured for easier decoding of URLLC data. A gNB transmitter 2914 may transmit the eMBB and URLLC communication for reception by eMBB device receiver 2924. The eMBB device may identify presence or absence of URLLC data in the signal received by eMBB device receiver 2924. For instance, decoding may be blind and an eMBB device may check multiple numerologies in a pre-determined resource area or blocks. Information about the presence or absence of URLLC data may be explicitly signaled by an eMBB or URLLC indication or control channel. Any indications of pre-emption may be decoded 2926 and subsequently URLLC data may be decoded 2928 with more reliability since the communication is transmitted or scaled with greater power. Subsequently, received symbols are processed 2930 and the URLLC data communication reconstructed. URLLC interference from the received signal may be eliminated using a SIC receiver or transceiver and may subsequently be utilized to decode the eMBB data 2932.

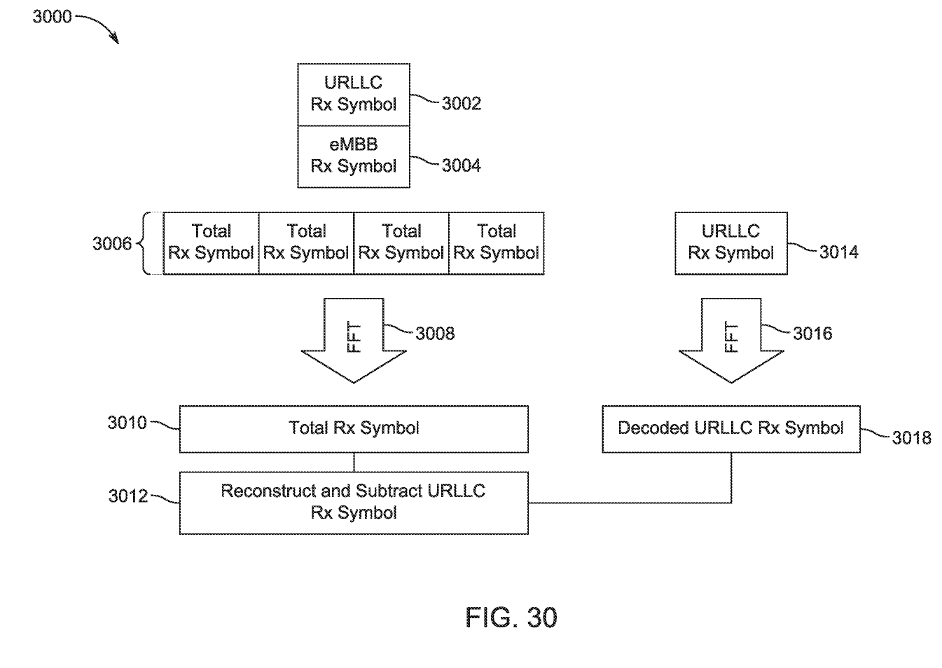

FIG. 30 is a process 3000 of an example where numerology of the eMBB data is not changed. A combined URLLC received symbol 3002 and eMBB received symbol 3004 may be processed by a WTRU, such as WTRU 102. After processing of total received repetition symbols 3006 at FFT 3008, a total received symbol 3010 is recovered. Similarly, the URLLC received symbol 3014 is processed at FFT 3016 and decoded at 3018. To recover the eMBB received symbol 3004, reconstruction and subtraction of the decoded URLLC received symbol 3018 is performed at 3012.

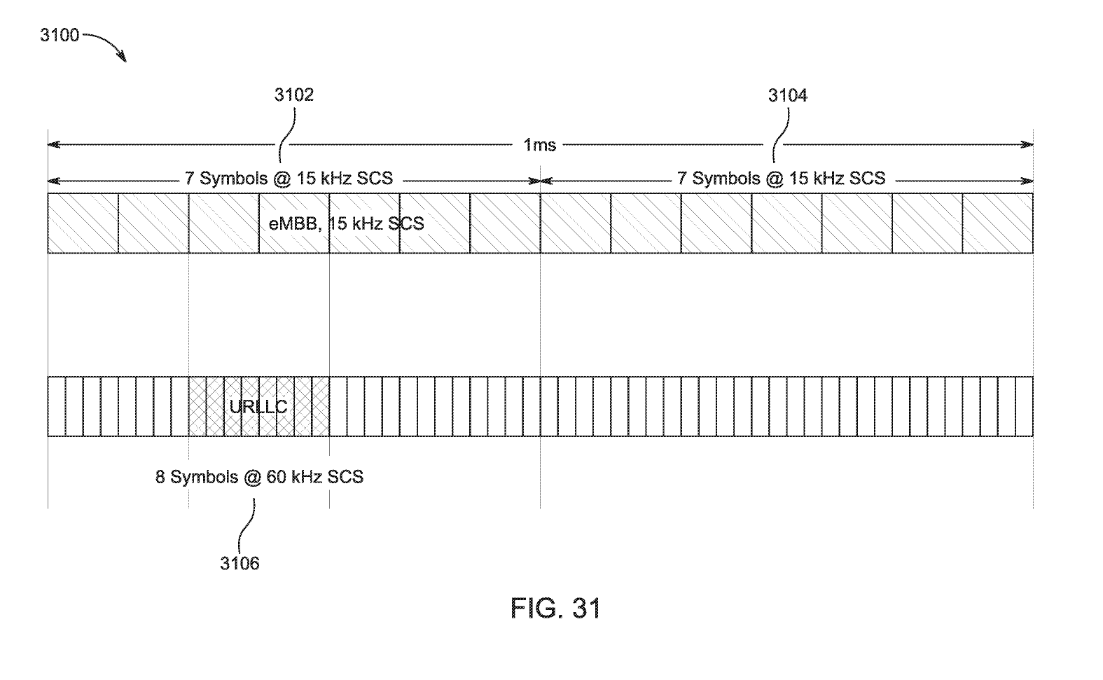

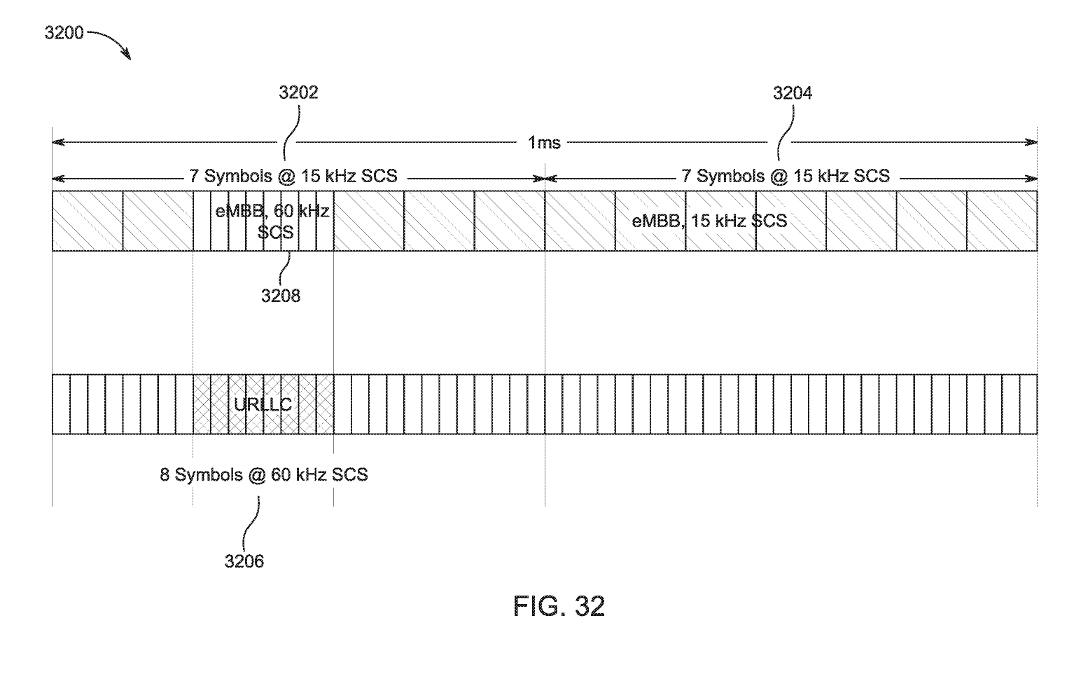

FIG. 31 is a signal diagram 3100 illustrating baseline URLLC traffic insertion. A 1 ms subframe for eMBB communications may have a first slot 3102 of 7 symbols at a 15 kHz SCS and a second slot 3104 of 7 symbols at 15 kHz SCS. URLLC may be multiplexed and inserted 3106 in 8 symbols at 60 kHz SCS. Moreover, FIG. 32 is a signal diagram 3200 showing an example of URLLC traffic Insertion with dynamic eMBB numerology. A 1 ms subframe for eMBB communications may have a first slot 3202 of 7 symbols at 15 kHz SCS and a second slot 3204 of 7 symbols at 15 kHz SCS. URLLC may be multiplexed and inserted 3206 in 8 symbols at 60 kHz SCS. Dynamic numerology may be utilized in first slot 3202 by changing eMBB to 60 kHz SCS at resources 3208.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A wireless transmit/receive unit (WTRU) comprising:
a processor configured to receive a configuration message that includes a plurality of scheduled resources to communicate a scheduling request (SR) for uplink (UL) transmission during a configured downlink slot for enhanced mobile broadband (eMBB) communication, wherein the configured downlink slot comprises a plurality of downlink (DL) mini-slots to switch communications for UL or DL ultra-reliable low latency communication (URLLC) information;
a transceiver configured to transmit, on one of the plurality of scheduled resources, the SR for transmission of URLLC data;
the processor configured to monitor a physical downlink control channel (PDCCH) for an UL grant on the plurality of DL mini-slots following the SR; and
the transceiver configured to transmit, on a condition of receiving the UL grant, the URLLC data on resources of a switched UL mini-slot of the plurality of DL mini-slots indicated by the UL grant.

2. The WTRU of claim 1, wherein on a condition that the UL grant is not received, the transceiver configured to transmit the URLLC data on configured grant-free UL resources of an UL mini-slot of the plurality of DL mini-slots.

3. The WTRU of claim 1, wherein the one of the plurality of scheduled resources or the resources of the switched UL mini-slot of the plurality of DL mini-slots is proximate to a radio resource allocation region (RRAR).

4. The WTRU of claim 1, wherein an eMMB device rate matches for decoding a physical downlink shared channel (PDSCH) around resources of a plurality of scheduled resources configured to communicate a pre-emptive scheduling request (PSR).

5. (canceled)

6. The WTRU of claim 1, wherein the plurality of DL mini-slots include UL/DL mini-slots.

7. (canceled)

8. The WTRU of claim 1, wherein resource blocks of the resources are super-imposed on eMMB resources.

9. (canceled)

10. The WTRU of claim 1, wherein sub-carrier spacing (SCS) of the resources is greater than SCS of eMMB resources.

11. A method performed by a wireless transmit/receive unit (WTRU), the method comprising:
receiving, by the WTRU, a configuration message that includes a plurality of scheduled resources to communicate a scheduling request (SR) for uplink (UL) transmission during a configured downlink slot for enhanced mobile broadband (eMBB) communication, wherein the configured downlink slot comprises a plurality of downlink (DL) mini-slots to switch communications for UL or DL ultra-reliable low latency communication (URLLC) information;
transmitting, by the WTRU on one of the plurality of scheduled resources, the SR for transmission of URLLC data;
monitoring, by the WTRU, a physical downlink control channel (PDCCH) for an UL grant on the plurality of DL mini-slots following the SR; and
transmitting, by the WTRU on a condition of receiving the UL grant, the URLLC data on resources of a switched UL mini-slot of the plurality of DL mini-slots indicated by the UL grant.

12. The method of claim 11, wherein on a condition that the UL grant is not received, transmitting, by the WTRU, the URLLC data on configured grant-free UL resources of an UL mini-slot of the plurality of DL mini-slots.

13. The method of claim 11, wherein the one of the plurality of scheduled resources or the resources of the switched UL mini-slot of the plurality of DL mini-slots is proximate to a radio resource allocation region (RRAR).

14. The method of claim 11, wherein an eMMB device rate matches for decoding a physical downlink shared channel (PDSCH) around resources of a plurality of scheduled resources configured to communicate a pre-emptive scheduling request (PSR).

15. (canceled)

16. The method of claim 11, wherein the plurality of DL mini-slots include UL/DL mini-slots.

17. (canceled)

18. The method of claim 11, wherein resource blocks of the resources are super-imposed on eMMB resources.

19. (canceled)

20. The method of claim 11, wherein sub-carrier spacing (SCS) of the resources is greater than SCS of eMMB resources.
